(19) United States
(12) Patent Application Publication
(10) Pub. No.: US 2009/0170984 A1
(43) Pub. Date: Jul. 2, 2009

(54) COMPOSITION CONTAINING POLYMERS, COLOURING AGENTS AND STABILISERS

(75) Inventors: Till Blum, Mannheim (DE); Alban Glaser, Mannheim (DE); Simon Schambony, Ludwigshafen (DE); Manfred Appel, Dernbach (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF SE, Ludwigshafen (DE)

(21) Appl. No.: 12/293,506

(22) PCT Filed: Mar. 30, 2007
(86) PCT No.: PCT/EP2007/053095

§ 371 Date: Sep. 18, 2008

(30) Foreign Application Priority Data
Mar. 31, 2006 (EP) 06006854.1

(51) Int. Cl. C08K 5/3435

(52) U.S. Cl. 524/99

(57) ABSTRACT

The invention relates to a composition containing at least one piperidine compound of formula (I) as a stabiliser. In said formula (I) the variables R1, R2, R3, R4, R5, R6, R7, R8, Y and the index n have the meanings cited in claim 1 and the description. Said composition also comprises a polymer component and a colouring agent. The invention further relates to a method for producing pigment-containing polymer compositions and to the use of the compounds of formula (I) as dispersing auxiliary agents.

The present invention relates to a composition which comprises at least one polymer, at least one colorant, and, as stabilizer, at least one piperidine compound. The stabilizer is intended in particular to protect the composition from exposure to light, oxygen and/or heat and also to ensure good color stability of the colored polymer. The present invention further relates to a process for producing a pigmented polymer composition by intimately contacting a polymer component with a pigment and using as dispersing assistant a piperidine compound, and also to the use of the piperidine compound as a dispersing assistant.

It is known that the mechanical, chemical and/or esthetic properties of plastics deteriorate on exposure to light, oxygen and/or heat. This deterioration on the part of the plastic, which is also referred to as aging, is typically manifested as yellowing, discoloration, cracking or embrittlement of the materials. As a general rule the aging is founded on oxidation reactions, which may be initiated by heat, light, mechanical stress, catalysis or reactions with contaminants. The aging phenomena of the plastics may appear during their production or their processing to moldings and/or while the moldings are in service. In order to reduce the decrease in mechanical properties and the discoloration of the products it is therefore common to stabilize plastics using stabilizers or stabilizer compositions.

Sterically hindered amines (hindered amine light stabilizers; HALS) are known stabilizers against photolytic and thermal decomposition of plastics. HALS compounds from the prior art are 2,2,6,6-tetraalkylpiperidine derivatives. The HALS compounds used for stabilizing may be either monomeric or oligomeric.

EP 0 316 582 and WO 01/74777 describe 4-formylamino-2,2,6,6-tetra(C₁-C₄)alkylpiperidine derivatives as effective light stabilizers for organic material, particularly for polyolefins, polyamides, and polyurethanes. Numerous stabilizer mixtures comprising monomeric HALS compounds have already been described in the prior art for the stabilization of pigmented polyolefins, examples being in EP 1 338 622, DE 197 35 974, and EP 1 342 748. WO 2005/054353 describes pigmented polystyrenes which comprise at least one UV absorber, at least one monomeric HALS compound, and at least one oligomeric HALS compound.

The monomeric HALS compounds known from the prior art are often unsatisfactory in terms of their performance properties. One major disadvantage is the frequently inadequate duration of the protective effect, owing to the low migration stability of monomeric HALS compounds. A further disadvantage is that many known light stabilizers have a distinctly perceptible intrinsic color in the visible wavelength range, which lessens the color intensity and brilliance of a colorant-comprising plastic. Moreover, many light stabilizers are of low solubility in the application medium. The crystallization of the light stabilizer that results from this may bring about clouding of the polymer, which is likewise unwanted. Consequently there continues to be a need for stabilizers and stabilizer compositions which exhibit improved performance properties.

The present invention is based on the object, therefore, of providing a stabilizer or stabilizer mixture having an improved profile of properties. In particular, a long-lasting protective effect at a high level ought to be achieved. The stabilizer or stabilizer mixture ought, furthermore, to be highly compatible with the polymers to be stabilized and to have a low level of intrinsic color. A further objective of the invention is to provide a process for producing pigmented polymer compositions. The pigmented polymer compositions obtained by the process of the invention ought to be more suitable for producing moldings than are known colorant-comprising polymer compositions, and in particular ought to enable a saving to be made in terms of pigment while allowing the same color strength to be retained as that of conventional polymer preparations.

These objects are achieved with the use of a piperidine compound of the formula (I)

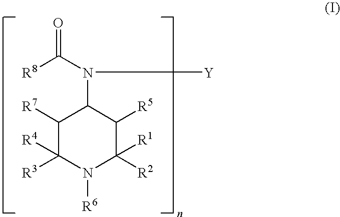

in which
n is 1 or 2;
R¹, R², R³, and R⁴ each independently are C₁-C₄-alkyl, or R¹ and R² and/or R³ and R⁴, together with the carbon atom to which they are attached, form a 4-, 5-, 6-, 7- or 8-membered ring;
R⁵ and R⁷ each independently are hydrogen or C₁-C₄-alkyl;
R⁶ is hydrogen, oxyl, hydroxyl, acyl, C₁-C₄₀-alkyl or C₂-C₄₀-alkenyl, it being possible for the two last-mentioned radicals to be interrupted by one or more non-adjacent groups selected independently of one another from oxygen, sulfur, —NH—, and N(C₁-C₁₀-alkyl)-, and/or to carry one or more substituents selected from cyano, hydroxyl, amino, and aryl, it being possible for aryl in turn to be substituted one or more times by C₁-C₄-alkyl, halogen, C₁-C₄-alkoxy, di(C₁-C₄-alkyl)amino, methylenedioxy or ethylenedioxy;
R⁸ is hydrogen or C₁-C₁₀-alkyl; and
if n is 1
Y is hydrogen or is C₁-C₂₂-alkyl which is unsubstituted or is substituted one or more times by identical or different radicals R^{a} and may be interrupted by one or more nonadjacent groups selected independently of one another from oxygen, sulfur, —NH— and N(C₁-C₁₀-alkyl)-; or
Y is C₃-C₂₂-alkenyl, C₃-C₁₂-cycloalkyl, C₆-C₁₂-bicycloalkyl or C₃-C₁₀-cycloalkenyl, in which the four last-mentioned radicals may carry one or more radicals R^{a}, and C₃-C₁₂-cycloalkyl, C₆-C₁₂-bicycloalkyl, and C₃-C₁₀-cycloalkenyl additionally may carry one or more alkyl groups, or
Y is aryl, in which aryl may be substituted one or more times by halogen, C₁-C₄-alkyl, C₁-C₄-alkoxy, C₁-C₄-alkoxycarbonyl, methylenedioxy, ethylenedioxy or di(C₁-C₄-alkyl)amino; or
Y is a heterocyclic ring which if appropriate carries one or more identical or different radicals selected from oxyl, hydroxyl, acyl, C₁-C₄₀-alkyl or C₂-C₄₀-alkenyl, it being possible for C₁-C₄₀-alkyl and C₂-C₄₀-alkenyl to be interrupted by one or more nonadjacent groups selected independently of one another from oxygen, sulfur, —NH— and N(C₁-C₁₀-alkyl)-, and/or to carry one or more substituents selected independently of one another from cyano, hydroxyl, amino, and aryl, it being possible for aryl in turn to be substituted one or more times by C₁-C₄-alkyl, halogen, C₁-C₄-alkoxy, di(C₁-C₄-alkyl)amino, methylenedioxy or ethylenedioxy;
R^{a} being cyano, amino, hydroxyl, hydroxy-C₁-C₄-alkoxy, C₁-C₄-alkoxycarbonyl, aryl or heterocyclyl, it being possible for the two last-mentioned radicals in turn to be substituted one or more times by halogen, hydroxyl, C₁-C₄-alkyl, C₁-C₄-alkoxy, C₁-C₄-alkoxycarbonyl, methylenedioxy, ethylenedioxy or di(C₁-C₄-alkyl)amino;
and if n is 2
Y is a divalent group having 1 to 30 bridge atoms between the flanking bonds, the divalent group having structural units selected from alkylene, alkenylene, arylene, heterocyclylene and cycloalkylene, it being possible for alkylene and alkenylene to be interrupted one or more times by oxygen, sulfur, —NH— and —N(C₁-C₁₀-alkyl)-, and for arylene, heterocyclylene, and cycloalkylene to be substituted one or more times by C₁-C₄-alkyl.

The present invention therefore provides firstly a composition comprising as stabilizer (i) at least one piperidine compound of the formula (I) as defined above, at least one polymer (ii), and at least one colorant (iii).

One specific embodiment of the present invention relates to a composition which further comprises at least one additive selected from antioxidants, light stabilizers, metal deactivators, antistatic agents, reinforcing agents, fillers, antifogging agents, and biocides.

The present invention further provides a process for producing a pigmented polymer composition comprising a continuous polymer phase and, dispersed therein, a particulate pigment phase, which comprises intimately contacting the polymer composition with the pigment and using as dispersing assistant at least one piperidine compound of the formula (I).

The present invention additionally provides for the use of a piperidine compound of the formula (I) as a dispersing assistant in a pigmented polymer composition.

For the purposes of the present invention the term “halogen” stands for fluorine, chlorine, bromine or iodine.

C₁-C₂₂-Alkyl stands for saturated, straight-chain or branched hydrocarbon radicals having 1 to 22 carbon atoms, examples being methyl, ethyl, propyl, isopropyl, n-butyl, isobutyl, sec-butyl, tert-butyl, n-pentyl, 2-pentyl, 2-methylbutyl, 3-methylbutyl, 1,2-dimethylpropyl, 1,1-dimethylpropyl, 2,2-dimethylpropyl, 1-ethylpropyl, n-hexyl, 2-hexyl, 2-methylpentyl, 3-methylpentyl, 4-methylpentyl, 1,2-dimethylbutyl, 1,3-dimethylbutyl, 2,3-dimethylbutyl, 1,1-dimethylbutyl, 2,2-dimethylbutyl, 3,3-dimethylbutyl, 1,1,2-trimethylpropyl, 1,2,2-trimethylpropyl, 1-ethylbutyl, 2-ethylbutyl, 1-ethyl-2-methylpropyl, n-heptyl, 2-heptyl, 3-heptyl, 2-ethylpentyl, 1-propylbutyl, n-octyl, 2-ethylhexyl, 2-propylheptyl, 1,1,3,3-tetramethylbutyl, nonyl, decyl, n-undecyl, n-dodecyl, n-tridecyl, isotridecyl, n-tetradecyl, n-hexadecyl, n-octadecyl, n-eicosyl, and the like.

C₁-C₄₀-Alkyl stands for saturated, straight-chain or branched hydrocarbon radicals having 1 to 40 carbon atoms, examples being C₁-C₂₂-alkyl, and also triacontanyl, tritriacontanyl or tetracontanyl.

If alkyl is interrupted by one or more, such as 1, 2, 3, 4, 5, 6, 7 or 8, non-adjacent groups selected independently of one another from oxygen, sulfur, —NH— and N(C₁-C₁₀-alkyl)-, then the termini of the alkyl group are formed by carbon atoms. Examples thereof are —(CH₂)₃N(CH₃)₂, —(CH₂)₃N(C₂H₅)₂, —(CH₂)₃—OCH₃, —(CH₂)₃—O—CH(CH₃)₂, —(CH₂)₂O(CH₂)₂—OCH₃, —CH₂—(CH₂)₂—CH₂—N(CH₂)₃, —(CH₂)₂—N[CH(CH₃)₂]₂, —(CH₂)₂—N(C₂H₅)₂, —(CH₂)₂N(CH₃)₂, —(CH₂)₂OCH₃, —(CH₂)₂OCH₂CH₃, —(CH₂)₃—SCH₃, —(CH₂)₃—S—CH(CH₃)₂, —(CH₂)₂S(CH₂)₂—SCH₃, —(CH₂)₂SCH₃, and —(CH₂)₂SCH₂CH₃.

C₁-C₄₀-Alkyl as defined above may have one or more, such as 1, 2, 3, 4, 5 or 6, substituents selected independently of one another from cyano, amino, hydroxyl, and aryl, it being possible for aryl in turn to be substituted one or more times, such as once, twice, three times or four times, by halogen, C₁-C₄-alkyl, C₁-C₄-alkoxy, methylenedioxy, ethylenedioxy or di(C₁-C₄-alkyl)amino.

If C₁-C₂₂-alkyl carries one or more identical or different radicals R^{a} then the alkyl group preferably carries 1, 2, 3, 4, 5 or 6 radicals R^{a}.

In the case of hydroxy-substituted alkyl the alkyl group preferably has one or two, in particular one, hydroxyl group(s), e.g., hydroxymethyl, 2-hydroxyeth-1-yl, 2-hydroxyprop-1-yl, 3-hydroxyprop-1-yl, 1-hydroxyprop-2-yl, 2-hydroxybut-1-yl, 3-hydroxybut-1-yl, 4-hydroxybut-1-yl, 1-hydroxybut-2-yl, 1-hydroxybut-3-yl, 2-hydroxybut-3-yl, 1-hydroxy-2-methylprop-3-yl, 2-hydroxy-2-methylprop-3-yl or 2-hydroxymethylprop-2-yl.

In the case of an amino substituent the alkyl group has preferably one or two, in particular one, amino group(s), e.g., aminomethyl, 2-aminoeth-1-yl, 2-aminoprop-1-yl, 3-aminoprop-1-yl, 1-aminoprop-2-yl, 2-aminobut-1-yl, 3-aminobut-1-yl, 4-aminobut-1-yl or 1-aminobut-2-yl.

In the case of hydroxy-C₁-C₄-alkoxy-substituted alkyl the alkyl group preferably has one or two, in particular one, hydroxy-C₁-C₄-alkoxy substituent(s).

In the case of C₁-C₄-alkoxycarbonyl-substituted alkyl the alkyl group has preferably one or two, in particular one, alkoxycarbonyl substituent(s), e.g., methoxycarbonylmethyl, ethoxycarbonylmethyl, 2-methoxycarbonylethyl, 1-methoxycarbonylethyl, 2-ethoxycarbonylethyl, 1-ethoxycarbonylethyl, n-propoxycarbonylmethyl, isopropoxycarbonylmethyl, n-butoxycarbonylmethyl, (1-methylpropoxy)carbonylmethyl or (2-methylcarbonylpropoxy)methyl.

In the case of cyano-substituted alkyl the alkyl group has preferably one or two, in particular one, cyano substituent(s), such as cyanomethyl or cyanoethyl.

In the case of aryl-substituted alkyl the alkyl group has preferably 1, 2, 3 or 4, in particular one or two, aryl substituent(s), it being possible for the aryl group in turn to be substituted one or more times, in particular one or two times, by C₁-C₄-alkyl, halogen, C₁-C₄-alkoxy, C₁-C₄-alkoxycarbonyl, methylenedioxy, ethylenedioxy or di(C₁-C₄-alkyl)amino. Preferably aryl is phenyl. Examples of phenyl-substituted alkyl comprise benzyl, methoxybenzyl, methylbenzyl, ethylbenzyl, isopropylbenzyl, trimethylbenzyl, fluorobenzyl, chlorobenzyl, methylenedioxybenzyl, phenylethyl, phenylpropyl, dimethylaminobenzyl, diphenylmethyl, and 1,3-diphenylprop-2-yl.

C₂-C₂₂-Alkenyl stands for monounsaturated, straight-chain or branched hydrocarbon radicals having 2 to 22 carbon atoms and a double bond in any position, e.g., ethenyl, 1-propenyl, 2-propenyl, 1-methylethenyl, 1-butenyl, 2-butenyl, 3-butenyl, 1-methyl-1-propenyl, 2-methyl-1-propenyl, 1-methyl-2-propenyl, 2-methyl-2-propenyl and the like. If the alkenyl group carries one or more substituents R^{a} then it may carry, for example, 1, 2, 3, 4 or 5 or 6 substituents R^{a}.

C₂-C₄₀-Alkenyl stands for monounsaturated, straight-chain or branched hydrocarbon radicals having 2 to 40 carbon atoms and a double bond in any position and can be interrupted by one or more, such as 1, 2, 3, 4, 5, 6, 7 or 8, nonadjacent groups selected independently of one another from oxygen, sulfur, —NH— and N(C₁-C₁₀-alkyl)- (i.e. the termini of the alkenyl group are formed by carbon atoms), and may if appropriate carry one or more, such as 1, 2, 3, 4, 5, 6, 7 or 8, substituents selected from cyano, hydroxyl, amino and aryl, it being possible for aryl in turn to be substituted one or more times by C₁-C₄-alkyl, halogen, C₁-C₄-alkoxy, di(C₁-C₄-alkyl)amino, methylenedioxy or ethylenedioxy.

Cycloalkyl stands for a monocyclic saturated hydrocarbon group having, for example, 3 to 12 carbon ring members, such as cyclopropyl, cyclobutyl, cyclopentyl, cyclohexyl, cycloheptyl, cyclooctyl, cyclononyl, cyclodecyl, and the like. Cycloalkyl may carry one or more radicals R^{a} and one or more, such as 1, 2, 3, 4, 5 or more than 5, alkyl groups, e.g., C₁-C₁₀-alkyl groups. If cycloalkyl is substituted by R^{a} then cycloalkyl carries generally 1, 2, 3, 4, 5, or 6 substituents R^{a}.

Bicycloalkyl is a bicyclic saturated hydrocarbon group having, for example, 6 to 12 carbon atoms, such as bicyclo[2.2.1]hept-1-yl, bicyclo[2.2.1]hept-2-yl, bicyclo[2.2.1]hept-7-yl, bicyclo[2.2.2]oct-1-yl, bicyclo[2.2.2]oct-2-yl, bicyclo[3.3.0]octyl, bicyclo[4.4.0]decyl, and the like. Bicycloalkyl may carry one or more radicals R^{a} and one or more, such as 1, 2, 3, 4, 5 or more than 5, alkyl groups, e.g., C₁-C₁₀-alkyl groups. If bicycloalkyl is substituted by R^{a} then bicycloalkyl carries generally 1, 2, 3, 4, 5 or 6 substituents R^{a}.

Cycloalkenyl is a monocyclic, monounsaturated hydrocarbon group having, for example, 3 to 10 carbon ring members, such as cyclopenten-1-yl, cyclopenten-3-yl, cyclohexen-1-yl, cyclohexen-3-yl, and the like. Cycloalkenyl may carry one or more radicals R^{a} and one or more, such as 1, 2, 3, 4, 5 or more than 5, alkyl groups, e.g., C₁-C₁₀-alkyl groups. If cycloalkenyl is substituted by R^{a} then cycloalkenyl carries generally 1, 2, 3, 4, 5 or 6 substituents R^{a}.

The expression “aryl” comprises for the purposes of the present invention monocyclic or polycyclic aromatic hydrocarbon radicals. The expression “aryl” stands preferably for phenyl, tolyl, xylyl, mesityl, duryl, naphthyl, fluorenyl, anthracenyl, phenanthrenyl or naphthyl, more preferably for phenyl or naphthyl. Aryl may be substituted one or more times, such as 1, 2, 3, 4, 5 or 6 times by C₁-C₄-alkyl, halogen, C₁-C₄-alkoxy, C₁-C₄-alkoxycarbonyl, methylenedioxy, ethylenedioxy or di(C₁-C₄-alkyl)amino.

The expression “acyl” comprises alkanoyl, hetaroyl and aroyl groups having generally 1 to 22, preferably 1 to 11, carbon atoms, examples being the formyl, acetyl, propionyl, butyryl, pentanoyl, hexanoyl, heptanoyl, 2-ethylhexanoyl, 2-propylheptanoyl, benzoyl or naphthoyl groups.

If n is 2 then Y is a divalent group having 1 to 30 bridge atoms between the flanking bonds, the divalent group having structural units—for example, one, two, three, four, five, six or seven structural units—which are selected from alkylene, alkenylene, arylene, heterocyclylene, and cycloalkylene, it being possible for alkylene and alkenylene to be interrupted one or more times by oxygen, sulfur, —NH— and —N(C₁-C₁₀-alkyl)- such as N(C₁-C₄-alkyl) and for arylene, heterocyclylene, and cycloalkylene to be substituted one or more times, such as once, twice, three times or four times, for example, by C₁-C₄-alkyl.

If Y comprises alkylene as a structural unit, then alkylene has preferably 1 to 30 carbon atoms and is a linear or branched, saturated hydrocarbon chain such as 1,1-ethanediyl, 1,2-ethanediyl, prop-1,2-ylene, prop-1,3-ylene, but-1,2-ylene, but-1,3-ylene, but-1,4-ylene, 2-methylprop-1,3-ylene, pent-1,2-ylene, pent-1,3-ylene, pent-1,4-ylene, pent-1,5-ylene, pent-2,3-ylene, pent-2,4-ylene, 1-methyl-1,4-butylene, hex-1,3-ylene, hex-2,4-ylene, hex-1,4-ylene, hex-1,5-ylene, hex-1,6-ylene, hept-1,7-ylene, oct-1,8-ylene and the like.

If Y comprises, as a structural unit, alkylene interrupted one or more times, such as once, twice, three times, four times, five times, six times, seven times or eight times, by oxygen, sulfur, —NH—, and —N(C₁-C₁₀-alkyl)- such as N(C₁-C₄-alkyl), then examples thereof comprise —(C₃H₆O)—C₃H₆—, —(C₃H₆O)₂—C₃H₆—, —(C₃H₆O)₃—C₃H₆—, —(C₃H₆O)₄—C₃H₆—, —(C₃H₆O)₅—C₃H₆—, —(CH₂)₃O(CH₂)₄O(CH₂)₃—, —(CH₂)₃O(CH₂)₂O(CH₂)₂O(CH₂)₂—, —(CH₂)₃O(CH₂)₂O(CH₂)₃—, —(CH₂)—[N(CH₃)]-(CH₂)₂—, —CH₂—C(CH₃)—[O(CH₂)₅CH₃]-CH₂—CH(CH₃)—CH₂—, —CH₂—C(CH₃)—[O(CH₂)₅CH₃]-CH₂—CH(C₂H₅)—CH₂—, —(C₃H₆S)—C₃H₆—, —(C₃H₆S)₂—C₃H₆—, —(C₃H₆S)₃—C₃H₆—, —(C₃H₆S)₄—C₃H₆—, —(C₃H₆S)₅—C₃H₆—, —(CH₂)₃S(CH₂)₄S(CH₂)₃—, —(CH₂)₃S(CH₂)₂S(CH₂)₂S(CH₂)₂—, —(CH₂)₃S(CH₂)₂S(CH₂)₃—, —CH₂—C(CH₃)—[S(CH₂)₅CH₃]-CH₂—CH(CH₃)—CH₂—, —CH₂—C(CH₃)—[S(CH₂)₅CH₃]-CH₂—CH(C₂H₅)—CH₂—.

If Y comprises alkenylene as a structural unit, then alkylene has preferably 2 to 30 carbon atoms and is a linear or branched, monounsaturated hydrocarbon chain.

If Y comprises arylene as a structural unit, arylene being unsubstituted or substituted one or more times, such as once, twice, three times or four times, by C₁-C₄-alkyl, then examples thereof comprise naphthylene, phenylene, and biphenylene.

If Y comprises cycloalkylene as a structural unit, then cycloalkylene preferably has 5 to 22 carbon atoms. Cycloalkylene may be unsubstituted or may carry one or more, such as 1, 2, 3 or 4, C₁-C₄-alkyl radicals such as methyl.

If Y comprises heterocyclylene as a structural unit, then heterocyclylene is preferably a 5-, 6-, 7-, 8-, 9- or 10-membered heterocyclic ring which comprises one, two, three or four heteroatoms, selected from O, S and N, as ring members. Heterocyclylene may be saturated, partially unsaturated or aromatic. The heterocycle preferably comprises two nitrogen atoms as ring members. The heterocycle may be unsubstituted or may carry one or more, such as 1, 2, 3 or 4, C₁-C₄-alkyl radicals such as methyl.

The expression “heterocyclic ring”, “heterocycle” or “heterocyclyl” stands for 5-, 6-, 7-, 8-, 9- or 10-membered heterocyclyl and comprises not only aromatic heterocyclyl (hetaryl or heteroaryl) but also fully saturated or partially unsaturated heterocyclic radicals. Heterocyclyl has 1, 2, 3 or 4 heteroatoms selected from O, S and N, e.g., 1, 2, 3 or 4 nitrogen atoms, 1, 2 or 3 nitrogen atoms, 1 or 2 oxygen atoms, or 1 oxygen atom and 1 or 2 nitrogen atoms or 1 sulfur atom and 1 or 2 nitrogen atoms. Preferably heterocyclyl comprises 5 or 6 ring atoms.

Heterocyclyl is unsubstituted or carries, if appropriate, one or more, such as 1, 2, 3, 4, 5, 6 or 7, identical or different radicals selected from oxyl, hydroxyl, acyl, C₁-C₄₀-alkyl or C₂-C₄₀-alkenyl, it being possible for C₁-C₄₀-alkyl and C₂-C₄₀-alkenyl to be interrupted by one or more nonadjacent groups selected independently of one another from oxygen, sulfur, —NH— and N(C₁-C₁₀-alkyl)-, and/or to carry one or more substituents selected independently from one another from cyano, hydroxyl, amino, and aryl, it being possible for aryl in turn to be substituted one or more times by C₁-C₄-alkyl, halogen, C₁-C₄-alkoxy, di(C₁-C₄-alkyl)amino, methylenedioxy or ethylenedioxy.

The piperidine compound of the formula (I) comprised in the composition is notable for a high level of compatibility with the polymer employed and colorant, in particular the pigment employed, for a low vapor pressure, and hence for a low migration tendency. Accordingly a composition of the invention in comparison with a composition comprising a prior-art stabilizer rather than a piperidine compound of the formula (I) exhibits an enhanced stability.

With regard to the use of the piperidine compound of the formula (I) in the composition of the invention it is preferred if the variables R¹, R², R³, R⁴, R⁵, R⁶, R⁷, and R⁸, independently of one another and, in particular, in combination, have the following definitions:
R¹, R², R³, R⁴ methyl;
R⁵, R⁷ hydrogen;
R⁸ hydrogen;
R⁶ hydrogen; C₁-C₁₀-alkyl, such as methyl, ethyl, n-propyl, butyl, pentyl, hexyl; C₁-C₄-cyanoalkyl, such as cyanomethyl or cyanoethyl; C₁-C₄-aminoalkyl such as aminomethyl, aminoethyl; C₁-C₄-hydroxyalkyl, such as hydroxymethyl or hydroxyethyl; phenyl-C₁-C₄-alkyl, such as benzyl, phenylethyl or phenylpropyl; tolyl-C₁-C₄-alkyl, such as 2-methylbenzyl, 3-methylbenzyl or 4-methylbenzyl; C₂-C₆-alkenyl, such as ally; acyl such as C₁-C₂₂-alkanoyl, examples being formyl, acetyl, propionyl, butanoyl or pentanoyl or benzoyl; in particular hydrogen, acetyl, cyanomethyl, aminoethyl, and especially hydrogen.

In one preferred embodiment of the present invention R¹, R², R³, and R⁴ are each methyl and R⁵ and R⁷ are each hydrogen.

If n is 1 then Y preferably has one of the following definitions:
i) hydrogen;
ii) C₁-C₂₂-alkyl, such as methyl, ethyl, n-propyl and isopropyl, n-butyl, sec-butyl, isobutyl, tert-butyl, n-pentyl, isopentyl, hexyl, octyl, decyl, dodecyl, octadecyl, 3,3-dimethylbut-2-yl, neopentyl, 4-methylpent-2-yl, and 2-ethylhexyl;
iii) C₁-C₁₀-alkyl substituted one or more times, such as one, two or three times, by identical or different radicals R^{a}: Examples thereof are:
   C₁-C₁₀-cyanoalkyl, such as cyanomethyl or cyanoethyl;
   C₁-C₁₀-hydroxyalkyl such as hydroxyethyl, hydroxypropyl, hydroxybutyl;
   C₁-C₄-alkoxycarbonyl-substituted C₁-C₁₀-alkyl, such as methoxycarbonylethyl and ethoxycarbonylethyl;
   phenyl-C₁-C₁₀-alkyl, it being possible for phenyl in turn to be substituted one or more times, such as once or twice, by C₁-C₄-alkyl, fluorine, chlorine, C₁-C₄-alkoxy, di(C₁-C₄-alkyl)amino or methylenedioxy, such as benzyl, methylbenzyl, ethylbenzyl, isopropylbenzyl, trimethylbenzyl, methoxybenzyl, fluorobenzyl, chlorobenzyl, dimethylaminobenzyl, 3,4-(methylenedioxy)benzyl, phenylethyl, phenylpropyl and phenylbutyl, diphenylmethyl, and 1,3-diphenylprop-2-yl;
   C₁-C₁₀-alkyl substituted by 5-, 6-, 7-, 8-, 9- or 10-membered saturated, partially saturated or aromatic heterocycle, the heterocycle comprising one, two, three or four heteroatoms selected as ring members from oxygen, nitrogen or sulfur and carrying, if appropriate, one or more, such as 1 or 2, substituents selected from oxyl, hydroxyl, acyl, C₁-C₁₀-alkyl or C₂-C₁₀-alkenyl, such as

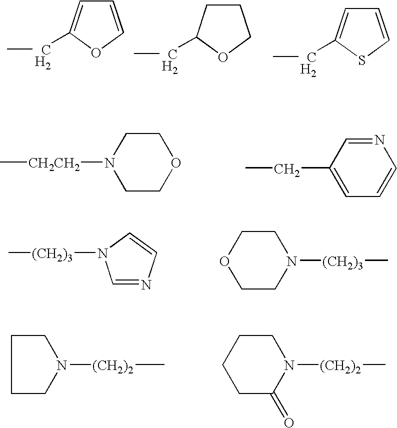

iv) C₄-C₂₂-alkyl interrupted by —O—, —S—, —NH— and —N(C₁-C₄-alkyl)-, and substituted, if appropriate, by hydroxyl, such as —(CH₂)₃N(CH₃)₂, —(CH₂)₃N(C₂H₅)₂, —(CH₂)₃—OCH₃, —(CH₂)₃—O—CH(CH₃)₂, —(CH₂)₂O—(CH₂)₂—OH, —CH₂—(CH₂)₂—CH₂—N(CH₂)₃, —(CH₂)₂—N[CH(CH₃)₂]₂, —(CH₂)₂—N(C₂H₅)₂, —(CH₂)₂N(CH₃)₂, —(CH₂)—₂OCH₃, and —(CH₂)₂OCH₂CH₃;
v) C₃-C₂₂-alkenyl, such as allyl, 1-butenyl, 1-pentenyl, and oleyl;
vi) C₃-C₁₂-cycloalkyl, such as cyclopropyl, cyclobutyl, cyclopentyl, cyclohexyl, methylcyclohexyl, cycloheptyl, cyclooctyl, cyclododecyl, especially cyclopentyl and cyclohexyl;
vii) C₆-C₁₂-bicycloalkyl such as bicycloheptyl;
viii) phenyl substituted if appropriate by C₁-C₄-alkyl or C₁-C₄-alkoxycarbonyl, such as phenyl, tolyl, methoxy- and ethoxycarbonylphenyl; or
ix) a radical of the formula

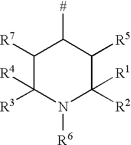

in which # stands for the linkage site to the amide nitrogen atom and R¹ to R⁷ are as defined above and in particular are as defined above as preferred.

If n is 2 then Y is a divalent group which links the two amide nitrogen atoms, and has preferably one of the following definitions:
a) C₁-C₁₂-alkylene, such as methylene, 1,2-ethanediyl, propane-1,3-diyl, butane-1,4-diyl, pentane-1,5-diyl, hexane-1,6-diyl, heptane-1,7-diyl, octane-1,8-diyl,

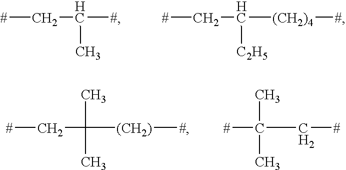

where # marks the linkage sites with the respective amide nitrogen atom, especially unbranched C₄-C₈-alkylene, very especially hexane-1,6-diyl;
b) is a divalent group having 1 to 30 bridge atoms between the flanking bonds, the divalent group having structural units selected from alkylene, alkylene being interrupted one or more times, such as once, twice, three times, four times, five times, six times, seven times or eight times, by oxygen, sulfur, —NH— and —N(alkyl)- such as —N(C₁-C₄-alkyl)-, such as —(CH₂)₃O(CH₂)₄O(CH₂)₃—, —(CH₂)₃O(CH₂)₂O(CH₂)₂O(CH₂)₃—, —(C₃H₆O)—C₃H₆—, —(C₃H₆O)₂—C₃H₆—, —(C₃H₆O)₃—C₃H₆—, —(C₃H₆O)₄—C₃H₆—, —(C₃H₆O)₅—C₃H₆—, —(CH₂)₃O(CH₂)₂O(CH₂)₃—,

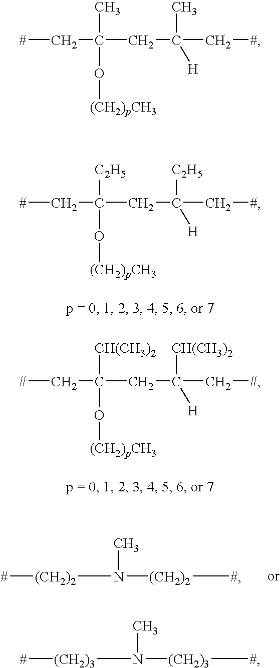

c) is a divalent group having 1 to 30 bridge atoms between the flanking bonds, the divalent group having structural units selected from alkylene, cycloalkylene, heterocyclylene and phenylene, it being possible for phenylene, heterocyclylene and cycloalkylene to be substituted one or more times, such as once, twice or three times, by C₁-C₄-alkyl, such as 1,2-phenylene, 1,3-phenylene, 1,4-phenylene,

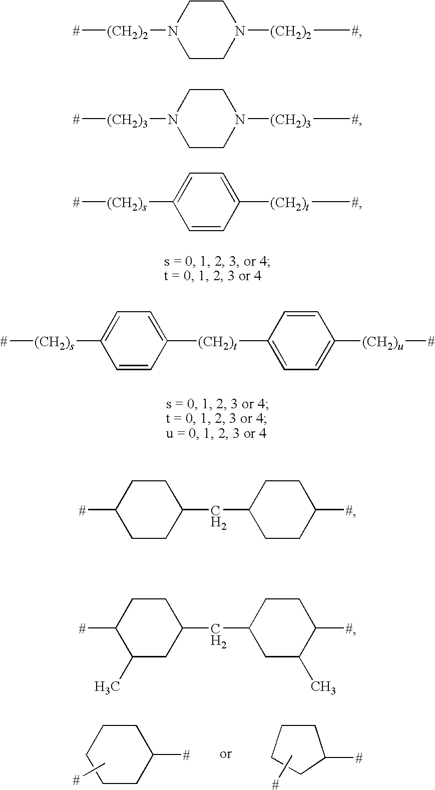

in which # marks the linkage sites of the group Y to the two amide nitrogen atoms.

In one particularly preferred embodiment of the present invention the variables R¹, R², R³, R⁴, R⁵, R⁶, R⁷, R⁸, and Y and also the index n in formula (I) have the following definitions: the index n is 2, R¹, R², R³, and R⁴ are each methyl, R⁵, R⁶, R⁷, and R⁸ are each hydrogen, and Y is hexane-1,6-diyl.

Compounds of the general formula (I) can be prepared by reacting compounds of the general formula (II) in which R¹, R², R³, R⁴, R⁵, R⁶, Y, and n are as defined above with formic acid or formic esters in the case of R⁸ being hydrogen, or with a C₁-C₁₀ carboxylic acid or a C₁-C₁₀ carboxylic ester if R⁸=C₁-C₁₀ alkyl. For these purposes the methyl ester and the ethyl ester are preferred. These reactions can be operated with or without catalyst. Catalysts may be Lewis acids, of which mention may be made in particular of titanium orthoesters and especially of titanium orthobutylate.

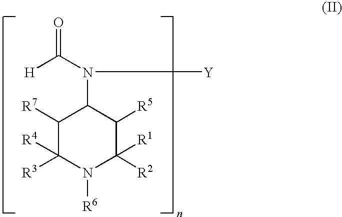

Reactions of this kind are described in EP 0 316 582.

Compounds of the general formula (I) with R⁶=H can be converted by conventional processes such as alkylation, reductive amination, reaction with glycolic acid nitrile, etc., into compounds of the general formula (I) in which R is unsubstituted or substituted alkyl, alkenyl, acyl. Examples of suitable alkylating agents include alkyl halides, such as alkyl chloride, alkyl bromide or alkyl iodide, examples being methyl chloride, methyl bromide or methyl iodide, or dialkyl sulfates such as dimethyl sulfate or diethyl sulfate. The reaction with the alkylating agent is carried out advantageously in the presence of a solvent. Solvents used for these reactions are—depending on temperature range—aliphatic, cycloaliphatic or aromatic hydrocarbons such as hexane, cyclohexane, toluene, xylene, chlorinated aliphatic and aromatic hydrocarbons such as dichloromethane, chlorobenzene, open-chain dialkyl ethers such as diethyl ether, di-n-propyl ether, methyl tert-butyl ether, cyclic ethers such as tetrahydrofuran, 1,4-dioxane, glycol ethers such as dimethyl glycol ether, or mixtures of these solvents.

Compounds of the general formula (I) with R⁶=H can be converted into the corresponding oxyl group by oxidation, for example. Suitable oxidizing agents include peroxides, such as hydrogen peroxide, tert-butyl hydroperoxide, cumene hydroperoxide, peracids, such as peracetic acid, meta-chloroperbenzoic acid, orthochloroperbenzoic acid, perbenzoic acid, para-nitroperbenzoic acid or magnesium monoperoxyphthalate. The oxidation can take place in an inert solvent, such as in a chlorinated hydrocarbon such as methylene chloride, in an aliphatic hydrocarbon such as petroleum ether or an aromatic hydrocarbon such as toluene, xylene, benzene or mixtures thereof.

The compounds of the formula (II) are either known from the literature or can be prepared by the person skilled in the art of organic synthesis, by modification of processes that are known per se.

In accordance with the invention the piperidine derivatives of the formula (I) are used for stabilizing a composition comprising polymer and at least one colorant against degradation by light and/or heat. In addition to this, the compounds (I) also have the capacity to act as metal deactivators.

One preferred embodiment of the present invention relates to a composition comprising as polymer ii) a halogenated polymer. The halogenated polymers include polychloroprene, chlorinated and fluorinated rubbers, chlorinated and brominated copolymer of isobutylene-isoprene (halogen rubber), chlorinated and sulfochlorinated polyethylene, copolymers of ethylene and chlorinated ethylene and chlorinated ethylene, epichlorohydrin homopolymers and copolymers, especially polymers of halogen-comprising vinyl compounds, e.g., polyvinyl chloride (PVC), polyvinylidene chloride (PVDC), polyvinyl fluoride, polyvinylidene fluoride, and copolymers thereof, such as vinyl chloride/vinylidene chloride, vinyl chloride/vinyl acetate or vinylidene chloride/vinyl acetate copolymers. Polyvinyl chloride is employed with a differing plasticizer content: with a plasticizer content of 0-12% as rigid PVC, of more than 12% as flexible PVC, and with a very high plasticizer content as PVC paste. Examples of typical plasticizers include phthalates, epoxides, and adipic esters.

Polyvinyl chloride is prepared by free-radical polymerization of vinyl chloride in bulk, suspension, microsuspension, and emulsion polymerization. The polymerization is frequently initiated by peroxides. PVC is employed diversely, as for example synthetic foam leather, insulating wall coverings, household articles, footwear soles, furniture profiles, floor coverings or pipes.

Polyvinylidene chloride is prepared by free-radical polymerization of vinylidene chloride. Vinylidene chloride can also be copolymerized with (meth)acrylates, vinyl chloride or acrylonitrile. Polyvinylidene chloride and also the vinylidene copolymers are processed for example to form films, but also to form profiles, pipes, and fibers. One important application concerns multilayer films; the good barrier properties of polyvinylidene chloride are also used for coatings.

A further preferred embodiment of the present invention relates to compositions wherein the polymer ii) is selected from homopolymers and copolymers of cyclic ethers, such as polyalkylene glycols, e.g., polyethylene oxide, polypropylene oxide or copolymers thereof with bisglycidyl ethers. Polyalkylene glycols come about through polyaddition of a cyclic ether such as ethylene oxide, propylene oxide or tetrahydrofuran, for example, with an OH compound as starter molecule, such as water. Starter molecules for the polyaddition may also be dihydric or polyhydric alcohols. Low molecular mass polyalkylene glycols are used as synthetic lubricants. Additionally, polyalkylene glycols are used as solubilizers for surfactant combinations, as binders in soaps, as ingredients in inks for writing and stamping, and as plasticizers and release agents.

A further preferred embodiment of the present invention relates to compositions wherein the polymer ii) is selected from polyacetals, copolymers of polyacetals with cyclic ethers, and polyacetals modified with thermoplastic polyurethanes, acrylates or methyl acrylate/butadiene/styrene copolymers. Polyacetals come about through polymerization of aldehydes or of cyclic acetals. One industrially significant polyacetal is polyoxymethylene (POM), which is obtainable through cationic or anionic polymerization of formaldehyde or trioxane, respectively. Modified POM is obtained, for example, by copolymerization with cyclic ethers such as ethylene oxide or 1,3-dioxolane. Combination of POM with thermoplastic polyurethane elastomers produces POM-based polymer blends. Unreinforced POM is notable for very high stiffness, strength, and toughness. POM is used preferably for constructing household appliances and for constructing apparatus, vehicles, and machinery, and in sanitary and installation engineering.

A further preferred embodiment of the present invention relates to compositions wherein the polymer ii) is selected from polyaryl ethers, polyaryl sulfides, and mixtures of polyaryl ethers with styrene polymers and polyamides. An example of polyaryl ethers are polyphenylene oxides, whose main chain is constructed from phenylene units which are linked via oxygen atoms and substituted if appropriate by alkyl groups. One industrially significant polyphenylene oxide is poly-2,6-dimethylphenyl ether. An example of polyaryl sulfides are polyphenylene sulfides, which are obtainable by polycondensation of 1,4-dichlorobenzene with sodium sulfide. They are notable for high strength, stiffness, and hardness. They are a suitable substitute for metals in the construction of pump housings and for other elements of mechanical engineering and apparatus construction. Further fields of use for polyphenylene sulfides are electrical engineering and electronics.

A further preferred embodiment of the present invention relates to compositions wherein the polymer ii) is selected from polyurethanes. Suitable polyisocyanate polyaddition products (polyurethanes) are, for example, cellular polyurethanes, examples being rigid or flexible polyurethane foams, compact polyurethanes, thermoplastic polyurethanes (TPUs), thermoset or elastic polyurethanes or polyisocyanurates. These polymers are common knowledge and their preparation has been widely described. They are typically prepared by reacting difunctional and higher polyfunctional isocyanates or corresponding isocyanate analogs with isocyanate-reactive compounds. The preparation takes place by typical methods, such as by the one-shot method or by the prepolymer method, in molds, in a reaction extruder or else on a belt unit, for example. One specific preparation process is the reaction injection molding (RIM) process, which is used preferably for preparing polyurethanes having a foamed or compact core and a predominantly compact, nonporous surface. Compound (I) and its derivatives are suitable advantageously for all of these processes.

Polyurethanes are generally synthesized from at least one polyisocyanate and at least one compound having at least two groups per molecule that are reactive toward isocyanate groups. Suitable polyisocyanates possess preferably 2 to 5 NCO groups. The groups that are reactive toward isocyanate groups are preferably selected from hydroxyl, mercapto, primary and secondary amino groups. Included here are preferably dihydric or higher polyhydric polyols.

Suitable polyisocyanates are aliphatic, cycloaliphatic, araliphatic and aromatic isocyanates. Suitable aromatic diisocyanates are, for example, diphenylmethane 2,2′-, 2,4′- and/or 4,4′-diisocyanate (MDI), naphthylene 1,5-diisocyanate (NDI), tolylene 2,4- and/or 2,6-diisocyanate (TDI), diphenylmethane diisocyanate, 3,3′-dimethyldiphenyl diisocyanate, 1,2-diphenylethane diisocyanate and/or phenylene diisocyanate. Aliphatic and cycloaliphatic diisocyanates comprise, for example, tri-, tetra-, penta-, hexa-, hepta- and/or octamethylene diisocyanate, 2-methylpentamethylene 1,5-diisocyanate, 2-ethylbutylene 1,4-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), cyclohexane 1,4-diisocyanate, 1-methyl-2,4- and/or 2,6-cyclohexanediisocyanato and/or dicyclohexylmethane 4,4′-, 2,4′- and/or 2,2′-diisocyanate. The preferred diisocyanates include hexamethylene diisocyanate (HMDI) and isophorone diisocyanate. Examples of higher polyfunctional isocyanates are triisocyanates, such as triphenylmethane 4,4′,4″-triisocyanate, and also the cyanurates of the aforementioned diisocyanates, and also the oligomers obtainable by partial reaction of diisocyanates with water, such as the biurets of the aforementioned diisocyanates, and, furthermore, oligomers obtainable by targeted reaction of semiblocked diisocyanates with polyols having on average more than 2 and preferably 3 or more hydroxyl groups.

Polyol components used in this context, for rigid polyurethane foams, which if appropriate may have isocyanurate structures, are high-functionality polyols, especially polyether polyols based on high-functionality alcohols, sugar alcohols and/or saccharides as starter molecules. For flexible polyisocyanate polyaddition products, such as flexible polyurethane foams or RIM materials, preferred polyols are 2- and/or 3-functional polyether polyols based on glycerol and/or trimethylolpropane and/or glycols as starter molecules, and 2- and/or 3-functional polyether polyols based on glycerol and/or trimethylolpropane and/or glycols as alcohols for esterification. Thermoplastic polyurethanes are based typically on predominantly difunctional polyester polyalcohols and/or polyether polyalcohols which preferably have an average functionality of 1.8 to 2.5, more preferably 1.9 to 2.1.

The preparation of the polyether polyols in this context takes place in accordance with a known technology. Examples of suitable alkylene oxides for preparing the polyols include propylene 1,3-oxide, butylene 1,2- and/or 2,3-oxide, styrene oxide, and, preferably, ethylene oxide and propylene 1,2-oxide. The alkylene oxides can be used individually, alternately in succession, or as mixtures. It is preferred to use alkylene oxides which lead to primary hydroxyl groups in the polyol. Polyols used with particular preference are those which to end the alkoxylation have been alkoxylated with ethylene oxide and so have primary hydroxyl groups. Further suitable polyetherols are polytetrahydrofurans and polyoxymethylenes. The polyether polyols possess a functionality of preferably 2 to 6 and in particular 2 to 4 and molecular weights of 200 to 10 000, preferably 200 to 8000.

Suitable polyester polyols can be prepared for example from organic dicarboxylic acids having 2 to 12 carbon atoms, preferably aliphatic dicarboxylic acids having 4 to 6 carbon atoms, and from polyhydric alcohols, preferably diols, having 2 to 12 carbon atoms, preferably 2 to 6 carbon atoms. The polyester polyols preferably possess a functionality of 2 to 4, in particular 2 to 3, and a molecular weight of 480 to 3000, preferably 600 to 2000, and in particular 600 to 1500.

The polyol component may further comprise diols or higher polyhydric alcohols. Suitable diols are glycols having preferably 2 to 25 carbon atoms. These include 1,2-ethanediol, 1,2-propanediol, 1,3-propanediol, 1,4-butanediol, 1,5-pentanediol, 1,6-hexanediol, 1,10-decanediol, diethylene glycol, 2,2,4-trimethylpentane-1,5-diol, 2,2-dimethylpropane-1,3-diol, 1,4-dimethylolcyclohexane, 1,6-dimethylolcyclohexane, 2,2-bis(4-hydroxyphenyl)propane (bisphenol A), 2,2-bis(4-hydroxyphenyl)butane (bisphenol B) or 1,1-bis(4-hydroxyphenyl)-3,3,5-trimethylcyclohexane (bisphenol C).

Suitable higher polyhydric alcohols are, for example, trihydric (triols), tetrahydric (tetrols) and/or pentahydric alcohols (pentols). They generally have 3 to 25, preferably 3 to 18 carbon atoms. They include glycerol, trimethylolethane, trimethylolpropane, erythritol, pentaerythritol, sorbitol, and the alkoxylates thereof.

To modify the mechanical properties, the hardness for example, it may nevertheless prove advantageous to add chain extenders, crosslinking agents, stoppers or else, if appropriate, mixtures of these. The chain extenders and/or crosslinking agents have for example a molecular weight of 40 to 300. Suitable examples include aliphatic, cycloaliphatic and/or araliphatic diols having 2 to 14, preferably 2 to 10 carbon atoms, such as ethylene glycol, 1,3-propanediol, 1,2-propanediol, 1,10-decanediol-, 1,2-, 1,3-, 1,4-dihydroxycyclohexane, diethylene glycol, dipropylene glycol, and, preferably, ethylene glycol, 1,4-butanediol, 1,6-hexanediol, and bis(2-hydroxyethyl)hydroquinone, triols, such as 1,2,4-, 1,3,5-trihydroxycyclohexane, glycerol, trimethylolpropane, triethanolamine, and low molecular mass, hydroxyl-containing polyalkylene oxides based on ethylene oxide and/or propylene 1,2-oxide and the aforementioned diols and/or triols as starter molecules. Suitable stoppers comprise, for example, monofunctional alcohols or secondary amines.

Polyurethanes are mostly processed to foams.

A further preferred embodiment of the present invention relates to compositions wherein the polymer ii) is selected from polyureas, polyimides, polyamideimides, polyetherimides, polyesterimides, polyhydantoins, and polybenzimidazoles. Polyureas come about as is known through polyaddition of diamines and diisocyanates. Polyimides, whose key structural element is the imide group in the main chain, come about through reaction of aromatic tetracarboxylic dianhydrides with aliphatic or aromatic diamines. Polyimides are used as, among other things, adhesives in composites, and also for coatings, thin films, as insulating material in microelectronics, for example, for high-modulus fibers, for semipermeable membranes, and as liquid-crystalline polymers.

A further preferred embodiment of the present invention relates to a composition wherein the polymer is selected from polyesters, preferably at least one linear polyester. Suitable polyesters and copolyesters are described in EP-A-0678376, EP-A-0 595 413, and U.S. Pat. No. 6,096,854, hereby incorporated by reference. Polyesters, as is known, are condensation products of one or more polyols and one or more polycarboxylic acids. In linear polyesters the polyol is a diol and the polycarboxylic acid a dicarboxylic acid. The diol component may be selected from ethylene glycol, 1,4-cyclohexanedimethanol, 1,2-propanediol, 1,3-propanediol, 1,4-butanediol, 2,2-dimethyl-1,3-propanediol, 1,6-hexanediol, 1,2-cyclohexanediol, 1,4-cyclohexanediol, 1,2-cyclohexanedimethanol, and 1,3-cyclohexanedimethanol. Also suitable are diols whose alkylene chain is interrupted one or more times by nonadjacent oxygen atoms. These include diethylene glycol, triethylene glycol, dipropylene glycol, tripropylene glycol, and the like. In general the diol comprises 2 to 18 carbon atoms, preferably 2 to 8 carbon atoms. Cycloaliphatic diols can be used in the form of their cis or trans isomers or as an isomer mixture. The acid component may be an aliphatic, alicyclic or aromatic dicarboxylic acid. The acid component of linear polyesters is generally selected from terephthalic acid, isophthalic acid, 1,4-cyclohexanedicarboxylic acid, 1,3-cyclohexanedicarboxylic acid, succinic acid, glutaric acid, adipic acid, sebacic acid, 1,12-dodecanedioic acid, 2,6-naphthalenedicarboxylic acid, and mixtures thereof. It will be appreciated that the functional derivatives of the acid component can also be employed, such as esters, examples being the methyl esters, or anhydrides or halides, preferably chlorides. Preferred polyesters are polyalkylene terephthalates, and polyalkylene naphthalates, which are obtainable by condensing terephthalic acid or naphthalenedicarboxylic acid, respectively, with an aliphatic diol.

Preferred polyalkylene terephthalates are polyethylene terephthalates (PET), which are obtained by condensing terephthalic acid with diethylene glycol. PET is also obtainable by transesterifying dimethyl terephthalate with ethylene glycol, with elimination of methanol, to form bis(2-hydroxyethyl) terephthalate, and subjecting the product to polycondensation, releasing ethylene glycol. Further preferred polyesters are polybutylene terephthalates (PBT), which are obtainable by condensing terephthalic acid with 1,4-butanediol, polyalkylene naphthalates (PAN) such as polyethylene 2,6-naphthalates (PEN), poly-1,4-cyclohexanedimethylene terephthalates (PCT), and also copolyesters of polyethylene terephthalate with cyclohexanedimethanol (PDCT), copolyesters of polybutylene terephthalate with cyclohexanedimethanol. Also preferred are copolymers, transesterification products, and physical mixtures (blends) of the aforementioned polyalkylene terephthalates. Particularly suitable polymers are selected from polycondensates and copolycondensates of terephthalic acid, such as poly- or copolyethylene terephthalate (PET or CoPET or PETG), poly(ethylene 2,6-naphthalate)s (PEN) or PEN/PET copolymers and PEN/PET blends. Said copolymers and blends, depending on their preparation process, may also comprise fractions of transesterification products.

PET and PBT are widely employed in the production of fibers and also exhibit high resistance as thermoplastic materials for industrial parts such as bearings, cogs, cam disks, rollers, switch housings, plugs, handles, operating buttons. PET is used to a high degree as a material for drinks bottles.

A further preferred embodiment of the present invention relates to compositions wherein the polymer ii) is selected from polycarbonates, polyestercarbonates, and mixtures thereof. Polycarbonates come about for example through condensation of phosgene or carbonic esters such as diphenyl carbonate or dimethyl carbonate with dihydroxy compounds. Suitable dihydroxy compounds are aliphatic or aromatic dihydroxy compounds. As aromatic dihydroxy compounds mention may be made for example of bisphenols such as 2,2-bis(4-hydroxyphenyl)propane (bisphenol A), tetraalkylbisphenol A, 4,4-(meta-phenylenediisopropyl)diphenol (bisphenol M), 4,4-(para-phenylenediisopropyl)diphenol, 1,1-bis(4-hydroxyphenyl)-3,3,5-trimethylcyclohexane (BP-TMC), 2,2-bis(4-hydroxyphenyl)-2-phenylethane, 1,1-bis(4-hydroxyphenyl)cyclohexane (bisphenol Z), and also, if appropriate, mixtures thereof. The polycarbonates may be branched by using small amounts of branching agents. Suitable branching agents include phloroglucinol, 4,6-dimethyl-2,4,6-tri(4-hydroxyphenyl)hept-2-ene, 4,6-dimethyl-2,4,6-tri(4-hydroxyphenyl)heptane; 1,3,5-tri(4-hydroxyphenyl)benzene; 1,1,1-tri(4-hydroxyphenyl)heptane; 1,3,5-tri(4-hydroxyphenyl)benzene; 1,1,1-tri(4-hydroxyphenyl)ethane; tri(4-hydroxyphenyl)phenylmethane, 2,2-bis[4,4-bis(4-hydroxyphenyl)cyclohexyl]-propane; 2,4-bis(4-hydroxyphenylisopropyl)phenol; 2,6-bis(2-hydroxy-5′-methylbenzyl)-4-methylphenol; 2-(4-hydroxyphenyl)-2-(2,4-dihydroxyphenyl)propane; hexa(4-(4-hydroxyphenylisopropyl)phenyl)ortho-terephthalic esters; tetra(4-hydroxyphenyl)methane; tetra(4-(4-hydroxyphenylisopropyl)phenoxy)methane; α,α′,α″-tris(4-hydroxyphenyl)-1,3,5-triisopropylbenzene; 2,4-dihydroxybenzoic acid; trimesic acid; cyanuric chloride; 3,3-bis(3-methyl-4-hydroxyphenyl)-2-oxo-2,3-dihydroindole, 1,4-bis(4′,4″-dihydroxytriphenyl)methyl)benzene, and, in particular, 1,1,1-tri(4-hydroxyphenyl)ethane and bis(3-methyl-4-hydroxyphenyl)-2-oxo-2,3-dihydroindole.

Examples of compounds suitable for chain termination include phenols such as phenol, alkylphenols such as cresol and 4-tert-butylphenol, chlorophenol, bromophenol, cumylphenol, or mixtures thereof. The fraction of chain terminators is generally 1 to 20 mol %, per mole of dihydroxy compound.

A further preferred embodiment of the present invention relates to compositions wherein the polymer ii) is selected from polysulfones, polyethersulfones, polyetherketones, and mixtures thereof. Polyetherketones are used for example in the electrical industry and in automotive engineering.

A further preferred embodiment of the present invention relates to compositions wherein the polymer ii) is selected from synthetic resins. The synthetic resins include crosslinked polymers derived from aldehydes on the one hand and from phenols, ureas, and melamines on the other, such as phenol/formaldehyde resins, urea/formaldehyde resins, and melamine/formaldehyde resins. The synthetic resins likewise include drying and nondrying alkyd resins and unsaturated polyester resins, derived from copolyesters of saturated and unsaturated dicarboxylic acids with polyhydric alcohols and vinyl compounds as crosslinking agents and also halogen-comprising modifications thereof of low flammability. The synthetic resins further include crosslinkable acrylic resins derived from substituted acrylates, such as epoxy acrylates, urethane acrylates or polyester acrylates. The synthetic resins additionally include alkyd resins, polyester resins, and acrylate resins crosslinked with melamine resins, urea resins, isocyanates, isocyanurates, polyisocyanates or epoxy resins, and crosslinked epoxy resins derived from aliphatic, cycloaliphatic, heterocyclic or aromatic glycidyl compounds. Epoxy resins come about, as is known, through ring-opening crosslinking reaction of polyfunctional epoxides. Examples of epoxy resins comprise diglycidyl ethers of bisphenol A or bisphenol F. They can be crosslinked with acid anhydrides or amines, with or without accelerator. The synthetic resins also include hydrocarbon resins, which typically have a molecular weight below 2000. The hydrocarbon resins can be classified in three groups: petroleum resins, terpene resins, and coal tar resins. The hydrocarbon resins also include, for the purposes of this invention, the hydrogenated modifications thereof and polyalkylenes.

A further preferred embodiment of the present invention relates to a composition wherein the polymer ii) is selected from natural polymers, such as cellulose, rubber, gelatin, and chemically modified derivatives thereof, examples being cellulose acetates, cellulose propionates, and cellulose butyrates, or the cellulose ethers, such as methylcellulose; and also rosin and its derivatives.

Cellulose is used principally as a blend with PET fibers in the clothing sector; and additionally as artificial silk, lining materials, curtain materials, tire cord, cotton wool, dressing materials, and sanitary articles. Cellulose esters are processed, for example, into screwdriver handles, spectacle frames, brushes, combs, ballpoint pens, industrial components such as vehicle steering wheels, lamp and instrument covers, typewriter keys, electrical insulating films, films for photographic use, and into light-resistant and heat-resistant thermoplastic binders for coating materials. Cellulose ethers serve as binders for transparent coating material for textiles, paper, films, and metals. Natural rubber (1,4-cis-polyisoprene) is indispensable for many applications, including radial tires for example.

A further preferred embodiment of the present invention relates to a composition wherein the polymer ii) is selected from naturally occurring and synthetic organic materials which are produced from pure monomeric compounds or mixtures of such compounds, examples being mineral oils, animal and vegetable fats, oils, and waxes, or oils, fats, and waxes based on synthetic esters, such as phthalates, adipates, phosphates or trimellitates, and also mixtures of synthetic esters with mineral oils in any desired weight ratios; generally those used as spinning agents; and also aqueous emulsions of such materials.

A further preferred embodiment of the present invention relates to a composition where the polymer ii) is selected from aqueous emulsions of natural or synthetic rubber. The aqueous emulsions of natural or synthetic rubber include natural latex or latices of carboxylated styrene/butadiene copolymers.

Another preferred embodiment of the present invention relates to a composition wherein the polymer ii) is selected from polyolefins and mixtures thereof.

For the purposes of the present invention the term “polyolefin” comprises all polymers composed of olefins without further functionality, such as polyethylene, polypropylene, polybut-1-ene or polyisobutylene, poly-4-methylpent-1-ene, polyisoprene, polybutadiene, polymers of cycloolefins, such as of cyclopentene or norbornene, and also copolymers of monoolefins or diolefins, such as polyvinylcyclohexane.

### Ethylene Polymers:

Suitable polyethylene (PE) homopolymers, classed according to density, are for example:
PE-ULD (ULD=ultralow density), PE-VLD (VLD=very low density); copolymers and terpolymers of ethylene with up to 10% octene, 4-methylpent-1-ene, and occasionally propylene; density between 0.91 and 0.88 g/cm³; barely crystalline, transparent
PE-LD (LD=low density), obtainable, for example, by the high-pressure process (ICI) at 1000 to 3000 bar and 150 to 300° C. with oxygen or peroxides as catalysts in autoclaves or tube reactors. Highly branched with branches of different length, crystallinity 40 to 50%, density 0.915 to 0.935 g/cm³, average molar mass up to 600 000 g/mol.
PE-LLD (LLD=linear low density), obtainable with metal complex catalysts in the low-pressure process from the gas phase, from a solution (e.g., benzine), in a suspension or with a modified high-pressure process. Slight branching with side chains which are themselves unbranched, molar masses higher than for PE-LD.
PE-MD (MD=middle density); the density between 0.93 and 0.94 g/cm³; can be prepared by mixing PE-LD and PE-HD or directly as a copolymeric PE-LLD.
PE-HD (HD=high density), obtainable by the medium-pressure (Phillips) and low-pressure (Ziegler) processes. By Phillips at 30 to 40 bar, 85 to 180° C., chromium oxide catalyst, molar masses about 50 000 g/mol. By Ziegler at 1 to 50 bar, 20 to 150° C., titanium halides, titanium esters or aluminum alkyls as catalysts, molar mass about 200 000 to 400 000 g/mol. Execution in suspension, solution, gas phase or bulk. Very slight branching, crystallinity 60% to 80%, density 0.942 to 0.965 g/cm³.
PE-HD-HMW (HMW=high molecular weight), obtainable by Ziegler, Phillips or gas-phase method. High density and high molar mass.
PE-HD-UHMW (UHMW=ultra high molecular weight) obtainable with modified Ziegler catalyst, molar mass 3 000 000 to 6 000 000 g/mol.

Particularly suitable polyethylene is that prepared in a gas-phase fluid-bed process using (typically supported) catalysts, e.g., Lupolen® (Basell, Netherlands).

Particular preference is given to polyethylene prepared using metallocene catalysts.

Such polyethylene is available commercially as, for example, Luflexen® (Basell, Netherlands).

Suitable ethylene copolymers are all commercial ethylene copolymers, examples being Luflexen® grades (Basell; Netherlands), Nordel® and Engage® (DuPont-Dow, USA). Examples of suitable comonomers include α-olefins having 3 to 10 carbon atoms, especially propylene, but-1-ene, hex-1-ene, and oct-1-ene, and also alkyl acrylates and methacrylates having 1 to 20 carbon atoms in the alkyl radical, especially butyl acrylate. Further suitable comonomers are dienes such as butadiene, isoprene, and octadiene, for example. Further suitable comonomers are cycloolefins, such as cyclopentene, norbornene, and dicyclopentadiene.

The ethylene copolymers are typically random copolymers or block or impact copolymers. Suitable block or impact copolymers of ethylene and comonomers are, for example, polymers for which in the first stage a homopolymer of the comonomer or a random copolymer of the comonomer is prepared, containing up to 15% by weight of ethylene, and then in the second stage a comonomer-ethylene copolymer with ethylene contents of 15% to 80% by weight is polymerized on. Ordinarily, sufficient of the comonomer-ethylene copolymer is polymerized on for the copolymer produced in the second stage to have a fraction of 3% to 60% by weight in the end product.

The polymerization for preparing the ethylene-comonomer copolymers can take place by means of a Ziegler-Natta catalyst system. It is, however, also possible to use catalyst systems based on metallocene compounds or based on polymerization-active metal complexes.

HDPE is used to produce principally toys, household articles, small industrial parts, and beer crates. Certain varieties of HDPE find use in disposable and mass-produced articles of everyday living. The field of use of LDPE extends from films through paper coating and on to thick- and thin-walled moldings. LLDPE exhibits advantages over LDPE in terms of the mechanical properties and in terms of resistance to stress cracking. LLDPE is employed especially for pipes and films.

### Propylene Polymers:

Polypropylene should be understood below to refer both to homopolymers and to copolymers of propylene. Copolymers of propylene comprise minor amounts of monomers copolymerizable with propylene, examples being C₂-C₈-alk-1-enes such as ethylene, but-1-ene, pent-1-ene or hex-1-ene, among others. It is also possible to use two or more different comonomers.

Suitable polypropylenes include homopolymers of propylene or copolymers of propylene with up to 50% by weight of copolymerized other alk-1-enes having up to 8 C atoms. The copolymers of propylene are in this case random copolymers or block or impact copolymers. Where the copolymers of propylene are of random construction they generally comprise up to 15% by weight, preferably up to 6% by weight, of other alk-1-enes having up to 8 C atoms, especially ethylene, but-1-ene or a mixture of ethylene and but-1-ene.

Suitable block or impact copolymers of propylene are, for example, polymers for which in the first stage a propylene homopolymer or a random copolymer of propylene with up to 15% by weight, preferably up to 6% by weight, of other alk-1-enes having up to 8 C atoms is prepared and then in the second stage a propylene-ethylene copolymer having ethylene contents of 15% to 80% by weight is polymerized on, the propylene-ethylene copolymer possibly further comprising additional C₄-C₈-alk-1-enes. Ordinarily, sufficient of the propylene-ethylene copolymer is polymerized on that the copolymer produced in the second stage has a fraction of 3% to 60% by weight in the end product.

The polymerization for preparing polypropylene can take place by means of a Ziegler-Natta catalyst system. In that case use is made in particular of catalyst systems which in addition to a titanium-containing solid component a) also contain cocatalysts in the form of organic aluminum compounds b) and electron donor compounds c).

It is also possible, however, to use catalyst systems based on metallocene compounds or based on polymerization-active metal complexes.

The preparation of the polypropylenes is carried out typically by polymerization in at least one reaction zone or, frequently, in two or more reaction zones connected in series (a reactor cascade), in the gas phase, in a suspension or in a liquid phase (bulk phase). The reactors used can be the typical reactors employed for polymerizing C₂-C₈-alk-1-enes. Suitable reactors include continuous stirred tanks, loop reactors, powder bed reactors or fluid bed reactors.

The polymerization for preparing the polypropylenes used is performed under typical reaction conditions at temperatures from 40 to 120° C., in particular from 50 to 100° C., and pressures from 10 to 100 bar, in particular from 20 to 50 bar.

Suitable polypropylenes generally have a melt flow rate (MFR), to ISO 1133, of 0.1 to 200 g/10 min, in particular from 0.2 to 100 g/10 min, at 230° C. under a weight of 2.16 kg.

In a further embodiment of the invention the plastic comprises at least one polyolefin. Preferred polyolefins comprise at least one monomer in copolymerized form, selected from ethylene, propylene, but-1-ene, isobutylene, 4-methyl-1-pentene, butadiene, isoprene, and mixtures thereof. Suitability is possessed by homopolymers, copolymers of the stated olefin monomers, and copolymers of at least one of the stated olefins as principal monomer, with other monomers (such as vinylaromatics, for example) as comonomers.

Preferred polyolefins are low-density polyethylene homopolymers (PE-LD) and polypropylene homopolymers and polypropylene copolymers. Preferred polypropylenes are, for example, biaxially oriented polypropylene (BOPP) and crystallized polypropylene. Preferred mixtures of the aforementioned polyolefins are, for example, mixtures of polypropylene with polyisobutylene, polypropylene with polyethylene (e.g., PP/HDPE, PP/LDPE), and mixtures of different kinds of polyethylene (e.g., LDPE/HDPE).

A further embodiment of the present invention relates to a composition wherein the polymer ii) is selected from copolymers of mono-olefins or diolefins with vinyl monomers and mixtures thereof. These include ethylene/propylene copolymers, linear low-density polyethylene (LLDPE) and mixtures thereof with low-density polyethylene (LDPE), propylene/but-1-ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, propylene/butadiene copolymers, isobutylene/isoprene copolymers, ethylene/alkyl acrylate copolymers, ethylene/alkyl methacrylate copolymers, ethylene/vinyl acetate copolymers, and copolymers thereof with carbon monoxide, or ethylene/acrylic acid copolymers and their salts (ionomers) and also terpolymers of ethylene with propylene and a diene, such as hexadiene, dicyclopentadiene or ethylidene-norbornene; and mixtures of such copolymers with one another and with polymers mentioned above, examples being polypropylene/ethylene-propylene copolymers, LDPE/ethylene-vinyl acetate copolymers, (EVA), LDPE/ethylene-acrylic acid copolymers, (EM), LLDPE/EVA, LLDPE/EM, and alternating or random polyalkylene carbon monoxide copolymers, and mixtures thereof with other polymers, polyamides for example.

A further preferred embodiment of the invention relates to a composition wherein the polymer ii) is selected from polymers derived from unsaturated alcohols and amines or from their acyl derivatives or acetals, such as polyvinyl acetate (PVAC) and polyvinyl alcohol (PVAL). The reaction of polyvinyl alcohol with an aldehyde produces polyvinylacetals; for example, on reaction with formaldehyde, the polyvinylformals (PVFM) or, with butyraldehyde, the polyvinylbutyrals (PVB). On account of their low glass transition temperature, polyvinyl compounds are not thermoplastic materials but instead are polymer resins. They are used as coating materials, such as for carpet-backing coatings, cheese coatings, paper coating slips, paint and pigment binders, paint base material, sizes, adhesives, protective colloids, chewing gum base, concrete additive, films for producing laminated glass for automotive windshields, and for many other purposes.

A further preferred embodiment of the invention relates to a composition wherein the polymer ii) is selected from polyamides (abbreviated code PA) or copolyamides which as key structural elements have amide groups in the main polymer chain. Polyamides can be prepared, for example, by polycondensation from diamines and dicarboxylic acids or their derivatives. Examples of suitable diamines include alkyldiamines such as C₂-C₂₀-alkyldiamines, e.g., hexamethylenediamine, or aromatic diamines, such as C₆-C₂₀ aromatic diamines, e.g., m-, o- or p-phenylenediamine or m-xylenediamine. Suitable dicarboxylic acids comprise aliphatic dicarboxylic acids or their derivatives, chlorides for example, such as C₂-C₂₀ aliphatic dicarboxylic acids, e.g., sebacic acid, decanedicarboxylic acid or adipic acid, or aromatic dicarboxylic acids, examples being C₆-C₂₀ aromatic dicarboxylic acids or their derivatives, chlorides for example, such as 2,6-naphthalenedicarboxylic acid, isophthalic acid or terephthalic acid. Examples of polyamides of this kind are poly-2,4,4-trimethylhexamethyleneterephthalamide or poly-m-phenyleneisophthalamide, PA 6,6 (polyhexamethyleneadipamide), PA 4,6 (polytetramethyleneadipamide), PA 6,10 (polyhexamethylenesebacamide), PA 6/9, PA 6/12, PA 4/6, PA 12/12, the first number in each case indicating the number of carbon atoms in the diamine and the second number the number of carbon atoms in the dicarboxylic acid.

Polyamides are likewise obtainable by polycondensation from amino acid, examples being C₂-C₂₀ amino acids such as 6-aminocaproic acid, 11-aminoundecanoic acid or by ring-opening polymerization from lactams, caprolactam for example. Examples of polyamides of this kind are PA 4 (synthesized from 4-aminobutyric acid), PA 6 (synthesized from 6-aminohexanoic acid). PA 11 is, for example, a polyundecanolactam, and PA 12 is a polydodecanolactam. In the case of polyamides which, as in this case, are synthesized only from one monomer, the number after the abbreviation PA indicates the number of carbon atoms in the monomer.

Polyamides can if appropriate be prepared with an elastomer as modifier. Examples of suitable copolyamides are block copolymers of the aforementioned polyamides with polyolefins, olefin copolymers, ionomers or chemically bonded or grafted elastomers; or with polyethers, such as with polyethylene glycol, polypropylene glycol or polytetramethylene glycol. Also suitable are EPDM- or ABS-modified polyamides or copolyamides, and polyamides condensed during processing (RIM polyamide systems).

Polyamide is used in injection moldings with stringent toughness, abrasion resistance, and thermal stability (dimensional stability) requirements, such as, for example, for plastic components in the engine compartment of automobiles; cogs, etc. In addition polyamide is used in synthetic fibers (e.g., nylon, Perlon).

A further preferred embodiment of the present invention relates to a composition wherein the polymer ii) is selected from polymers deriving from α,β-unsaturated acids and their derivatives, such as polyacrylates and polymethacrylates; polymethyl methacrylates (PMMA), polyacrylamides (PM), and polyacrylonitriles (PAC), impact-modified by butyl acetate. Polyacrylic acids come about, as is known, through polymerization of acrylic acid. The polymerization can be carried out as a solution polymerization in water, as a precipitation polymerization in benzene, for example, or as a suspension polymerization.

Polyacrylic acid is used in the form of its salts as a thickener and in aqueous media for coatings. Polyacrylic acid and its copolymers with acrylamide are used as suspension aids for pigments, as flocculants in water treatment, as drilling aids in mining, as paper auxiliaries, as an adhesive for metal/plastic bonds, and for many other purposes. Polyacrylic esters are employed principally as binders for paints and coating materials, in the paper industry in coating slips and as binders and sizing agents, for the finishing of textiles, in adhesives and sealants, as leather assistants, as elastomers, and for many other purposes. A major field of use for PMMA is as a hardening component in binders of film-forming resins. In combination with acrylates it produces high-grade coatings distinguished by their long-term adhesion, film toughness, gloss, and weather resistance. Resins of this kind are used in primers and coatings, emulsion paints and varnishes. PAA is used principally as a flocculent in water treatment, as a paper auxiliary and as a flotation assistant in mining. In addition it is used as a clarifying aid for fruit juices, textile auxiliary, as a crosslinker in coatings, in the leather sector for example, as a thickener in paint dispersions, in adhesives, and in numerous other applications. Fields of use for PAC are knitware, home textiles (e.g., covers, curtains, upholstery), and carpets.

A further preferred embodiment of the present invention relates to a composition wherein the polymer ii) is selected from copolymers of the monomers identified in the above paragraph with one another or with other unsaturated monomers, such as acrylonitrile/butadiene copolymers, acrylonitrile/alkyl acrylate copolymers, acrylonitrile/alkoxyalkyl acrylate or acrylonitrile/vinyl halide copolymers, or acrylonitrile/alkyl methacrylate/butadiene terpolymers.

A further preferred embodiment of the present invention relates to a composition wherein the polymer ii) is selected from polystyrene, poly(p-methylstyrene), poly(α-methylstyrene), copolymers of styrene or α-methylstyrene with dienes or acrylic derivatives, or graft copolymers of styrene or α-methylstyrene.

A further preferred embodiment of the present invention relates to a composition wherein the polymer ii) is a copolymer of styrene with acrylonitrile and butadiene and/or acrylic or methacrylic esters.

Unmodified styrene polymers can be processed to form foam materials used in construction and in packaging. Copolymers of styrene or α-methylstyrene with dienes or acrylic derivatives comprise styrene/butadiene, styrene/acrylonitrile, styrene/alkyl methacrylate, styrene/butadiene/alkyl acrylate, styrene/butadiene/alkyl methacrylate, styrene/maleic anhydride, styrene/acrylonitrile/methyl acrylate; mixtures with high impact toughness of styrene copolymers and another polymer, such as a polyacrylate, a diene polymer, or an ethylene/propylene/diene terpolymer; and block copolymers of styrene, such as styrene/butadiene/styrene, styrene/isoprene/styrene, styrene/ethylene/butylene/styrene or styrene/ethylene/propylene/styrene.

Graft copolymers of styrene or α-methylstyrene, e.g., styrene on polybutadiene, styrene on polybutadiene-styrene or polybutadiene-acrylonitrile copolymers; styrene and acrylonitrile (or methacrylonitrile) on polybutadiene; styrene, acrylonitrile, and methyl methacrylate on polybutadiene; styrene and maleic anhydride on polybutadiene; styrene, acrylonitrile, and maleic anhydride or maleimide on polybutadiene; styrene and maleimide on polybutadiene; styrene and alkyl acrylates or methacrylates on polybutadiene; styrene and acrylonitrile on ethylene/propylene/diene terpolymers; styrene and acrylonitrile on polyalkyl acrylates or polyalkyl methacrylates, styrene and acrylonitrile on acrylate/butadiene copolymers, and also mixtures thereof with polyureas, polyimides, polyamide-imides, polyetherimides, polyesterimides, polyhydantoins, and polybenzimidazoles, examples being the copolymer mixtures known as ABS, MBS, ASA or AES polymers.

Prime applications for ABS are components, examples being casings for electrical and electronic devices (phones), and automotive components.

A further preferred embodiment of the present invention relates to a composition where the polymer ii) is a polymer blend. The term “polymer blend” refers to a mixture of two or more polymers or copolymers. Polymer blends serve to enhance the properties of the base component.

Examples of polymer blends comprise PP/EPDM, polyamide/EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PUR, PC/thermoplastic PUR, POM/acrylates, POM/MBS, PPO/HIPS, PPO/PA 6,6 and copolymers, methyl methacrylateacrylonitrile/butadiene/styrene polymers (MABS), PA/HDPE, PA/PP, PA/PPO, PBT/PC/ABS or PBT/PET/PC.

Acrylonitrile-butadiene-styrene copolymers (ABS) are thermoplastic or elastic polymer blends. They are produced by graft polymerizing the three base monomers, acrylonitrile, butadiene, and styrene, in an emulsion polymerization process or bulk polymerization process. The properties of ABS can be controlled via the proportions of the monomers employed.

Inventively the composition comprises at least one colorant iii). The term colorant comprises not only dyes but also pigments. Preferably the colorant is a pigment. The pigment may be an organic or inorganic pigment. Likewise regarded as colorants are organic compounds which exhibit fluorescence in the visible part of the electromagnetic spectrum, such as fluorescent dyes. The colorant may also have further properties such as electrical conductivity, or may be magnetically shielding.

Examples of suitable inorganic coloring pigments are white pigments such as titanium dioxide in its three modifications of rutile, anatase or brookite, lead white, zinc white, zinc sulfide or lithopones; black pigments such as carbon black, black iron oxide, iron manganese black or spinel black; chromatic pigments such as chromium oxide, chromium oxide hydrate green, cobalt green or ultramarine green, cobalt blue, iron blue, Milori blue, ultramarine blue or manganese blue, ultramarine violet or cobalt and manganese violet, red iron oxide, cadmium sulfoselenide, molybdate red or ultramarine red; brown iron oxide, mixed brown, spinel phases and corundum phases or chromium orange; yellow iron oxide, nickel titanium yellow, chromium titanium yellow, cadmium sulfide, cadmium zinc sulfide, chromium yellow, zinc yellow, alkaline earth metal chromates, Naples yellow; bismuth vanadate, effect pigments such as interference pigments and luster pigments.

Suitable inorganic pigments comprise: Pigment White 6, Pigment White 7, Pigment Black 7, Pigment Black 11, Pigment Black 22, Pigment Black 27/30, Pigment Yellow 34, Pigment Yellow 35/37, Pigment Yellow 42, Pigment Yellow 53, Pigment Brown 24, Pigment Yellow 119, Pigment Yellow 184, Pigment Orange 20, Pigment Orange 75, Pigment Brown 6, Pigment Brown 29, Pigment Brown 31, Pigment Yellow 164, Pigment Red 101, Pigment Red 104, Pigment Red 108, Pigment Red 265, Pigment Violet 15, Pigment Blue 28/36, Pigment Blue 29, Pigment Green 17, Pigment Green 26/50.

Examples of suitable organic pigments are aniline black, anthrapyrimidine pigments, azomethine pigments, anthraquinone pigments, monoazo pigments, disazo pigments, benzimidazolone pigments, quinacridone pigments, quinophthalone pigments, diketopyrrolopyrrole pigments, dioxazine pigments, flavanthrone pigments, indanthrone pigments, indolinone pigments, isoindoline pigments, isoindolinone pigments, thioindigo pigments, metal complex pigments, perinone pigments, perylene pigments, pyranthrone pigments, phthalocyanine pigments, thioindigo pigments, triarylcarbonium pigments or metal complex pigments.

Suitable organic pigments comprise: C.I. (Colour Index) Pigment Yellow 93, C.I. Pigment Yellow 95, C.I. Pigment Yellow 138, C.I. Pigment Yellow 139, C.I. Pigment Yellow 155, C.I. Pigment Yellow 162, C.I. Pigment Yellow 168, C.I. Pigment Yellow 180, C.I. Pigment Yellow 183, C.I. Pigment Red 44, C.I. Pigment Red 170, C.I. Pigment Red 202, C.I. Pigment Red 214, C.I. Pigment Red 254, C.I. Pigment Red 264, C.I. Pigment Red 272, C.I. Pigment Red 48:2, C.I. Pigment Red 48:3, C.I. Pigment Red 53:1, C.I. Pigment Red 57:1, C.I. Pigment Green 7, C.I. Pigment Blue 15:1, C.I. Pigment Blue 15:3, C.I. Pigment Violet 19.

Some of the specified pigments, such as carbon black or titanium dioxide, for example, also have the capacity to function as a filler or reinforcing agent and/or as a nucleating agent.

Particular preference is given to white and black pigments, especially to titanium dioxide in its three modifications, and carbon black. Also particularly preferred are white or black pigments in combination with an organic or inorganic pigment.

Examples of suitable dyes are: azo dyes, pyrazolone dyes, anthraquinone dyes, perinone dyes, perylene dyes, indigo and thioindigo dyes, and azomethine dyes.

In one specific embodiment of the present invention the pigment particle has an average size of less than 5 μm as determined by dynamic light scattering. The average particle size is preferably in the range from 0.1 nm to 2 μm, in particular in the range from 1 nm to 1 μm, and with very particular preference in the range from 5 nm to 0.5 μm.

The pigment content of the composition of the invention is guided by the color requirement the product produced from the composition of the invention is intended to exhibit, and may therefore vary very widely. Preferably the pigment component iii) is used in an amount of 0.0001% to 10% by weight, preferably 0.001% to 5% by weight, more preferably 0.01% to 3% by weight, and very preferably 0.1% to 2% by weight, based on the total weight of the composition of the invention.

The way in which the pigment component iii) is added is not subject to any restriction. The pigment can be added in finely divided form without further additive, as a solid or melt, or in the form of a premix with an additive, solvent for example. Particularly suitable for dust-free coloring are pigment preparations in which the additive is a polymer or a polymer composition. Premixes of this kind are also referred to as masterbatches in the context of the present invention. The polymer comprised in the masterbatch, or the polymer composition comprised in the masterbatch, is preferably the same polymer or polymer composition as the polymer component ii). The masterbatch product may be in solid or liquid form. If appropriate the masterbatch product may also be a paste. The masterbatch product may comprise further additives, of the kind described below. Component iii) may be added before, during, and after the preparation of the polymer. It is preferably added after the polymerization of the polymer. Pigment component iii) can be incorporated into the polymer using all known apparatus and methods of incorporation by mixing.

The stabilizer component i) may be added in solid or liquid form before, during or after the preparation of the polymer. Pigment component iii) and stabilizer component i) may also be incorporated together or in succession before, during or after the preparation of the polymer.

The composition of the invention typically comprises at least one compound of the formula (I) in an amount of 0.01% to 5% by weight, preferably 0.02% to 2.5% by weight, and with particular preference 0.1% to 1.0% by weight, based on the total weight of the composition. By the total weight of the composition is meant the weight of the composition to which the compound (I) and also, if appropriate, further additives have been added (polymer+pigment+sum of all other additives).

The composition of the invention may further comprise at least one additive selected from antioxidants, light stabilizers, metal deactivators, antistatic agents, reinforcing agents, fillers, antifogging agents, and biocides. Preferably the composition of the invention comprises no metal deactivator other than the compound of the formula (I).

The antioxidants, light stabilizers, and metal deactivators that are used additionally if appropriate have a high migration fastness and temperature resistance. Suitable antioxidants, light stabilizers, and metal deactivators are selected, for example, from groups a) to s):

a) 4,4-diarylbutadienes,
b) cinnamic esters,
c) benzotriazoles,
d) hydroxybenzophenones,
e) diphenylcyanoacrylates,
f) oxamides (oxalamides),
g) 2-phenyl-1,3,5-triazines;
h) antioxidants,
i) nickel compounds,
j) sterically hindered amines,
k) metal deactivators,
l) phosphites and phosphonites,
m) hydroxylamines,
n) nitrones,
o) amine oxides,
p) benzofuranones and indolinones,
q) thiosynergists,
r) peroxide scavengers, and
s) basic costabilizers.

Group a) of the 4,4-diarylbutadienes includes for example compounds of the formula A.

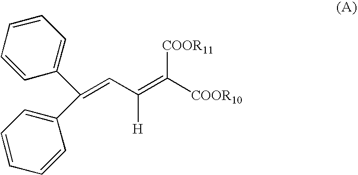

The compounds are known from EP-A-916 335. The substituents R₁₀ and/or R₁₁, are preferably C₁-C₈ alkyl and C₅-C₈ cycloalkyl.

Group b) of the cinnamic esters includes for example isoamyl 4-methoxycinnamate, 2-ethylhexyl 4-methoxycinnamate, methyl α-methoxycarbonylcinnamate, methyl α-cyano-β-methyl-p-methoxycinnamate, butyl α-cyano-β-methyl-p-methoxycinnamate, and methyl α-methoxycarbonyl-p-methoxycinnamate.

Group c) of the benzotriazoles includes for example 2-(2′-hydroxyphenyl)benzotriazoles such as 2-(2′-hydroxy-5′-methylphenyl)benzotriazole, 2-(3′,5′-di-tertbutyl-2′-hydroxyphenyl)benzotriazole, 2-(5′-tert-butyl-2′-hydroxyphenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chlorobenzotriazole, 2-(3′-tert-butyl-2′-hydroxy-5′-methylphenyl)-5-chlorobenzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis-(α,α-dimethylbenzyl)-2′-hydroxyphenyl)benzotriazole, 2-(3′-tert-butyl-2′-hydroxy-5′-(2-octyloxycarbonylethyl)phenyl)-5-chlorobenzotriazole, 2-(3′-tert-butyl-5′-[2-(2-ethylhexyloxy)carbonylethyl]-2′-hydroxyphenyl)-5-chlorobenzotriazole, 2-(3′-tert-butyl-2′-hydroxy-5′-(2-methoxycarbonylethyl)phenyl)-5-chlorobenzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonylethyl)phenyl)benzotriazole, 2-(3′-tert-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole and 2-(3′-tert-butyl-2′-hydroxy-5′-(2-isooctyloxycarbonylethyl)phenylbenzotriazole, 2,2′-methylenebis[4-(1,1,3,3-tetramethylbutyl)-6-benzotriazol-2-ylphenol]; the product of esterifying 2-[3′-tert-butyl-5′-(2-methoxycarbonylethyl)-2′-hydroxyphenyl]-2H-benzotriazole with polyethylene glycol 300; [R—CH₂CH₂—COO(CH₂)₃]₂ where R=3′-tert-butyl-4′-hydroxy-5′-2H-benzotriazol-2-ylphenyl, and mixtures thereof.

Group d) of the hydroxybenzophenones includes for example 2-hydroxybenzophenones such as 2-hydroxy-4-methoxybenzophenone, 2,2′-dihydroxy-4-methoxybenzophenone, 2,4-dihydroxybenzophenone, 2,2′,4,4′-tetrahydroxybenzophenone, 2,2′-dihydroxy-4,4′-dimethoxybenzophenone, 2,2′-dihydroxy-4,4′-dimethoxybenzophenone, 2-hydroxy-4-(2-ethylhexyloxy)benzophenone, 2-hydroxy-4-(n-octyloxy)benzophenone, 2-hydroxy-4-methoxy-4′-methylbenzophenone, 2-hydroxy-3-carboxybenzophenone, 2-hydroxy-4-methoxybenzophenone-5-sulfonic acid and its sodium salt, and 2,2′-dihydroxy-4,4′-dimethoxybenzophenone-5,5′-bissulfonic acid and its sodium salt.

Group e) of the diphenylcyanoacrylates includes for example ethyl 2-cyano-3,3-diphenylacrylate, obtainable commercially for example under the name Uvinul® 3035 from BASF AG, Ludwigshafen, Germany, 2-ethylhexyl 2-cyano-3,3-diphenylacrylate, obtainable commercially for example as Uvinul® 3039 from BASF AG, Ludwigshafen, and 1,3-bis[(2′-cyano-3′,3′-diphenylacryloyl)oxy]-2,2-bis{[2′-cyano-3′,3′-diphenylacryloyl)oxy]methyl}propane, obtainable commercially for example under the name Uvinul® 3030 from BASF AG, Ludwigshafen.

Group f) of the oxamides includes for example 4, 4′-dioctyloxyoxanilide, 2,2′-diethoxyoxanilide, 2,2′-dioctyloxy-5,5′-di-tert-butyloxanilide, 2,2′-didodecyloxy-5,5′-di-tertbutyloxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tertbutyloxanilide, and also mixtures of ortho-, para-methoxy-disubstituted oxanilides and mixtures of ortho- and para-ethoxy-disubstituted oxanilides.

Group g) of the 2-phenyl-1,3,5-triazines includes for example 2-(2-hydroxyphenyl)-1,3,5-triazines such as 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropoxy)phenyl]-4,6-bis(2,4-dimethylphenyl)-1,3,5-triazine, 2-[2-hydroxy-4-(2-hydroxy-3-octyloxypropoxy)phenyl]-4,6-bis(2,4-dimethylphenyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis-(2,4-dimethylphenyl)-1,3,5-triazine, 2-(2-hydroxy-4-hexyloxyphenyl)-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, and 2-(2-hydroxyphenyl)-4-(4-methoxyphenyl)-6-phenyl-1,3,5-triazine.

Group h) of the antioxidants includes, for example:
h.1) Alkylated monophenols such as, for example, 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(α-methylcyclohexyl)-4,6-dimethylphenol, 2,6-dioctadecyl-4-methylphenol, 2,4,6-tricyclohexylphenol, 2,6-di-tert-butyl-4-methoxymethylphenol, unbranched or sidechain-branched nonylphenols such as, for example, 2,6-dinonyl-4-methylphenol, 2,4-dimethyl-6-(1-methylundec-1-yl)phenol, 2,4-dimethyl-6-(1-methylheptadec-1-yl)phenol, 2,4-dimethyl-6-(1-methyltridec-1-yl)phenol, and mixtures thereof.
h.2) Alkylthiomethylphenols such as, for example, 2,4-dioctylthiomethyl-6-tert-butylphenol, 2,4-dioctylthiomethyl-6-methylphenol, 2,4-dioctylthiomethyl-6-ethylphenol and 2,6-didodecylthiomethyl-4-nonylphenol.
h.3) Hydroquinones and alkylated hydroquinones such as, for example, 2,6-di-tertbutyl-4-methoxyphenol, 2,5-di-tert-butylhydroquinone, 2,5-di-tert-amylhydroquinone, 2,6-diphenyl-4-octadecyloxyphenol, 2,6-di-tert-butylhydroquinone, 2,5-di-tert-butyl-4-hydroxyanisole, 3,5-di-tert-butyl-4-hydroxyanisole, 3,5-di-tertbutyl-4-hydroxyphenyl stearate, and bis-(3,5-di-tert-butyl-4-hydroxyphenyl) adipate.
h.4) Tocopherols, such as, for example, α-tocopherol, β-tocopherol, γ-tocopherol, δ-tocopherol, and mixtures thereof (vitamin E).
h.5) Hydroxylated thiodiphenyl ether such as, for example, 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol), and 4,4′-bis(2,6-dimethyl-4-hydroxyphenyl) disulfide.
h.6) Alkylidenebisphenols such as, for example, 2,2′-methylenebis(6-tert-butyl-4-methylphenol), 2,2′-methylenebis(6-tert-butyl-4-ethylphenol), 2,2′-methylenebis[4-methyl-6-(α-methylcyclohexyl)phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methylphenyl)-3-n-dodecylmercaptobutane, ethylene glycol bis[3,3-bis(3-tert-butyl-4-hydroxyphenyl)butyrate], bis(3-tert-butyl-4-hydroxy-5-methyl-phenyl)dicyclopentadiene, bis[2-(3′-tert-butyl-2-hydroxy-5-methylbenzyl)-6-tert-butyl-4-methylphenyl]terephthalate, 1,1-bis(3,5-dimethyl-2-hydroxyphenyl)butane, 2,2-bis(3,5-di-tert-butyl-4-hydroxyphenyl)propane, 2,2-bis-(5-tert-butyl-4-hydroxy-2-methylphenyl)-4-n-dodecylmercaptobutane, 1,1,5,5-tetra-(5-tert-butyl-4-hydroxy-2-methylphenyl)pentane.
h.7) Benzyl compounds such as, for example, 3,5,3′,5′-tetra-tert-butyl-4,4′-dihydroxydibenzyl ether, octadecyl 4-hydroxy-3,5-dimethylbenzylmercaptoacetate, tridecyl 4-hydroxy-3,5-di-tert-butylbenzylmercaptoacetate, tris(3,5-di-tert-butyl-4-hydroxybenzyl)amine, 1,3,5-tri(3,5-di-tert-butyl-4-hydroxybenzyl)-2,4,6-trimethylbenzene, di(3,5-di-tert-butyl-4-hydroxybenzyl) sulfide, isooctyl 3,5-di-tert-butyl-4-hydroxybenzylmercaptoacetate, bis(4-tert-butyl-3-hydroxy-2,6-dimethylbenzyl)dithiol terephthalate, 1,3,5-tris(3,5-di-tert-butyl-4-hydroxybenzyl) isocyanurate, 1,3,5-tris(4-tert-butyl-3-hydroxy-2,6-dimethylbenzyl) isocyanurate, 3,5-di-tert-butyl-4-hydroxybenzyl-phosphoric acid dioctadecyl ester, and 3,5-di-tert-butyl-4-hydroxybenzyl-phosphoric acid monoethyl ester, calcium salt.
h.8) Hydroxybenzylated malonates such as, for example, dioctadecyl 2,2-bis(3,5-di-tert butyl-2-hydroxybenzyl)malonate, dioctadecyl-2-(3-tert-butyl-4-hydroxy-5-methylbenzyl)malonate, didodecyl mercaptoethyl-2,2-bis(3,5-di-tert-butyl-4-hydroxybenzyl)malonate, and bis[4-(1,1,3,3-tetramethylbutyl)phenyl] 2,2-bis(3,5-di-tert-butyl-4-hydroxybenzyl)malonate.
h.9) Hydroxybenzyl aromatics such as, for example, 1,3,5-tris(3,5-di-tert-butyl-4-hydroxybenzyl)-2,4,6-trimethylbenzene, 1,4-bis(3,5-di-tert-butyl-4-hydroxybenzyl)-2,3,5,6-tetramethylbenzene, and 2,4,6-tris(3,5-di-tert-butyl-4-hydroxybenzyl)phenol.
h.10) Triazine compounds such as, for example, 2,4-bis(octylmercapto)-6-(3,5-di-tertbutyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris(3,5-di-tert-butyl-4-hydroxyphenoxy)-1,3,5-triazine, 1,3,5-tris(3,5-di-tert-butyl-4-hydroxybenzyl) isocyanurate, 1,3,5-tris(4-tert-butyl-3-hydroxy-2,6-dimethylbenzyl) isocyanurate, 2,4,6-tris(3,5-ditert-butyl-4-hydroxyphenylethyl)-1,3,5-triazine, 1,3,5-tris(3,5-di-tert-butyl-4-hydroxyphenylpropionyl)hexahydro-1,3,5-triazine, and 1,3,5-tris(3,5-dicyclohexyl-4-hydroxybenzyl) isocyanurate.
h.11) Benzylphosphonates such as, for example, dimethyl 2,5-di-tert-butyl-4-hydroxybenzylphosphonate, diethyl 3,5-di-tert-butyl-4-hydroxybenzylphosphonate (diethyl (3,5-bis(1,1-dimethylethyl)-4-hydroxyphenyl)methylphosphonate), dioctadecyl 3,5-di-tert-butyl-4-hydroxybenzylphosphonate, dioctadecyl 5-tert-butyl-4-hydroxy-3-methylbenzylphosphonate, and the calcium salt of monoethyl 3,5-di-tert-butyl-4-hydroxybenzylphosphonate.
h.12) Acylaminophenols such as, for example, 4-hydroxylauranilide, 4-hydroxystearanilide, 2,4-bisoctylmercapto-6-(3,5-tert-butyl-4-hydroxyanilino)-s-triazine, and octyl N-(3,5-di-tert-butyl-4-hydroxyphenyl)carbamate.
h.13) Esters of β-(3,5-di-tert-butyl-4-hydroxyphenyl)propionic acid with monohydric or polyhydric alcohols such as, for example, with methanol, ethanol, n-octanol, isooctanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis(hydroxyethyl)oxalamide, 3-thiaundecanol, 3-thiapentadecanol, trimethylhexanediol, trimethylolpropane, and 4-hydroxymethyl-1-phospha-2,6,7-trioxabicyclo-[2.2.2]octane.
h.14) Esters of β-(5-tert-butyl-4-hydroxy-3-methylphenyl)propionic acid with monohydric or polyhydric alcohols such as, for example, with methanol, ethanol, n-octanol, isooctanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis(hydroxyethyl)oxalamide, 3-thiaundecanol, 3-thiapentadecanol, trimethylhexanediol, trimethylolpropane, and 4-hydroxymethyl-1-phospha-2,6,7-trioxabicyclo[2.2.2]octane.
h.15) Esters of β-(3,5-dicyclohexyl-4-hydroxyphenyl)propionic acid with monohydric or polyhydric alcohols such as, for example, with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis(hydroxyethyl)oxalamide, 3-thiaundecanol, 3-thiapentadecanol, trimethylhexanediol, trimethylolpropane, and 4-hydroxymethyl-1-phospha-2,6,7-trioxabicyclo[2.2.2]octane.
h.16) Esters of 3,5-di-tert-butyl-4-hydroxyphenylacetic acid with monohydric or polyhydric alcohols such as, for example, with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis(hydroxyethyl)oxalamide, 3-thiaundecanol, 3-thiapentadecanol, trimethylhexanediol, trimethylolpropane, and 4-hydroxymethyl-1-phospha-2,6,7-trioxabicyclo[2.2.2]octane.
h.17) Amides of β-(3,5-di-tert-butyl-4-hydroxyphenyl)propionic acid such as, for example, N,N′-bis(3,5-di-tert-butyl-4-hydroxyphenylpropionyl)hexamethylenediamine, N,N′-bis(3,5-di-tert-butyl-4-hydroxyphenylpropionyl)trimethylenediamine, N,N′-bis(3,5-di-tert-butyl-4-hydroxyphenylpropionyl)hydrazine, N,N′-bis[2-(3-[3,5-di-tert-butyl-4-hydroxyphenyl]propionyloxy)ethyl]oxamide (e.g., Naugard® XL-1 from Uniroyal).
h.18) Ascorbic acid (vitamin C)
h.19) Aminic antioxidants such as, for example, N,N′-diisopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluenesulfamoyl)diphenylamine, N,N′-dimethyl-N,N′-di-sec-butyl-p-phenylenediamine, diphenylamine, N-allyldiphenylamine, 4-isopropoxydiphenylamine, N-phenyl-1-naphthylamine, N-(4-tert-octylphenyl)-1-naphthylamine, N-phenyl-2-naphthylamine, octylated diphenylamine, for example, p,p′-di-tert-octyldiphenylamine, 4-n-butylaminophenol, 4-butyrylaminophenol, 4-nonanoylaminophenol, 4-dodecanoylaminophenol, 4-octadecanoylaminophenol, bis(4-methoxyphenyl)amine, 2,6-di-tert-butyl-4-dimethylaminomethylphenol, 2,4′-diaminodiphenylmethane, 4,4′-diaminodiphenylmethane, N,N,N′,N′-tetramethyl-4,4′-diaminodiphenylmethane, 1,2-bis[(2-methylphenyl)amino]ethane, 1,2-bis(phenylamino)propane, (o-tolyl) biguanide, bis[4-(1′,3′-dimethylbutyl)phenyl]amine, tert-octylated N-phenyl-1-naphthylamine, a mixture of mono- and dialkylated tert-butyl/tertoctyldiphenylamines, a mixture of mono- and dialkylated nonyidiphenylamines, a mixture of mono- and dialkylated dodecyldiphenylamines, a mixture of mono- and dialkylated isopropyl/isohexyldiphenylamines, a mixture of mono- and dialkylated tert-butyldiphenylamines, 2,3-dihydro-3,3-dimethyl-4H-1,4-benzothiazine, phenothiazine, a mixture of mono- and dialkylated tert-butyl/tert-octylphenothiazines, a mixture of mono- and dialkylated tert-octylphenothiazines, N-allylphenothiazine, N,N,N′,N′-tetraphenyl-1,4-diaminobut-2-ene, N,N-bis(2,2,6,6-tetramethylpiperidin-4-yl)hexamethylenediamine, bis(2,2,6,6-tetramethylpiperidin-4-yl) sebacate, 2,2,6,6-tetramethylpiperidin-4-one, 2,2,6,6-tetramethylpiperidin-4-ol, the dimethyl succinate polymer with 4-hydroxy-2,2,6,6-tetramethyl-1-piperidineethanol [CAS number 65447-77-0], (for example, Tinuvin® 622 from Ciba Specialty Chemicals, Switzerland), polymer of 2,2,4,4-tetramethyl-7-oxa-3,20-diazadispiro[5.1.11.2]heneicosan-21-one and epichlorohydrin [CAS No.: 202483-55-4], (for example Hostavin® N30 from Clariant, Frankfurt am Main, Germany.).

Group i) of the nickel compounds includes for example nickel complexes of 2,2′-thiobis[4-(1,1,3,3-tetramethylbutyl)phenol], such as the 1:1 or 1:2 complex, with or without additional ligands such as n-butylamine, triethanolamine or N-cyclohexyldiethanolamine, nickel dibutyl dithiocarbamate, nickel salts of 4-hydroxy-3,5-di-tert-butylbenzylphosphonic acid monoalkyl esters such as of the methyl or ethyl esters, for example, nickel complexes of ketoximes such as, for example, of 2-hydroxy-4-methylphenyl undecyl ketoxime, and the nickel complex of 1-phenyl-4-lauroyl-5-hydroxypyrazole, with or without additional ligands.

Group j) of the sterically hindered amines includes for example bis(2,2,6,6-tetramethyl-4-piperidyl) sebacate, bis(2,2,6,6-tetramethyl-4-piperidyl) succinate, bis(1,2,2,6,6-pentamethyl-4-piperidyl) sebacate, bis(1-octyloxy-2,2,6,6-tetramethyl-4-piperidyl) sebacate, bis(1,2,2,6,6-pentamethyl-4-piperidyl) n-butyl-3,5-di-tert-butyl-4-hydroxybenzylmalonate, condensation product of 1-(2-hydroxyethyl)-2,2,6,6-tetramethyl-4-hydroxypiperidine and succinic acid, the condensation product of N,N′-bis(2,2,6,6-tetramethyl-4-piperidyl)hexamethylenediamine and 4-tert-octylamino-2,6-dichloro-1,3,5-triazine, tris(2,2,6,6-tetramethyl-4-piperidyl) nitrilotriacetate, tetrakis(2,2,6,6-tetramethyl-4-piperidyl) 1,2,3,4-butanetetracarboxylate, 1,1′-(1,2-ethylene)bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethyl-4-piperidyl) 2-n-butyl-2-(2-hydroxy-3,5-di-tert-butylbenzyl)malonate, 3-n-octyl-7,7,9,9-tetramethyl-1,3,8-triazaspiro[4.5]decane-2,4-dione, bis(1-octyloxy-2,2,6,6-tetramethyl-4-piperidyl) sebacate, bis(1-octyloxy-2,2,6,6-tetramethyl-4-piperidyl) succinate, condensation product of 2-chloro-4,6-bis(4-n-butylamino-2,2,6,6-tetramethyl-4-piperidyl)-1,3,5-triazine and 1,2-bis(3-aminopropylamino)ethane, condensation product of 2-chloro-4,6-di-(4-n-butylamino-1,2,2,6,6-pentamethyl-4-piperidyl)-1,3,5-triazine and 1,2-bis(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidine-2,5-dione, 3-dodecyl-1-(1,2,2,6,6-pentamethyl-4-piperidyl)pyrrolidine-2,5-dione, mixture of 4-hexadecyloxy- and 4-stearyloxy-2,2,6,6-tetramethylpiperidine, condensation product of N,N′-bis(2,2,6,6-tetramethyl-4-piperidyl)hexamethylenediamine and 4-cyclohexylamino-2,6-dichloro-1,3,5-triazine, condensation product of 1,2-bis(3-aminopropylamino)ethane and 2,4,6-trichloro-1,3,5-triazine and also 4-butylamino-2,2,6,6-tetramethylpiperidine, N-(2,2,6,6-tetramethyl-4-piperidyl)-n-dodecylsuccinimide, N-(1,2,2,6,6-pentamethyl-4-piperidyl)-n-dodecylsuccinimide, 2-undecyl-7,7,9,9-tetramethyl-1-oxa-3,8-diaza-4-oxospiro[4.5]decane, condensation product of 7,7,9,9-tetramethyl-2-cycloundecyl-1-oxa-3,8-diaza-4-oxospiro[4.5]decane and epichlorohydrin, poly[methoxypropyl-3-oxo-4-(2,2,6,6-tetramethyl-4-piperidyl)]siloxane, polymer-analogous reaction products derived from 4-amino-2,2,6,6-tetramethylpiperidine and maleic acid/C₂₀-C₂₄-α-olefin copolymers, e.g., Uvinul® 5050H (BASF Aktiengesellschaft, Ludwigshafen), and corresponding with polymer-analogous reaction products, 4-amino-1,2,2,6,6-pentamethylpiperidine (e.g., “methylated Uvinul® 5050H”), condensation products of tetramethylolacetylenediurea and 4-amino-2,2,6,6-tetramethylpiperidine, e.g., Uvinul® 4049H (BASF Aktiengesellschaft, Ludwigshafen), and corresponding condensation products with 4-amino-1,2,2,6,6-pentamethylpiperidine (e.g., “methylated Uvinul® 4049H”), poly[[6-[(1,1,3,3-tetramethylbutyl)amino]-1,3,5-triazine-2,4-diyl][(2,2,6,6-tetramethyl-4-piperidinyl)imino]-1,6-hexanediyl[(2,2,6,6-tetramethyl-4-piperidinyl)imino]] [CAS No. 71878-19-8], N,N′,N″,N′″-tetrakis{4,6-bis[butyl(N-methyl-2,2,6,6-tetramethyl-4-piperidyl)amino]triazin-2-yl}-4,7-diazadecane-1,10-diamine (CAS No. 106990-43-6) (e.g., Chimassorb® 119 from Ciba Specialty Chemicals, Switzerland).

Group k) of the metal deactivators includes for example N,N′-diphenyloxalamide, N-salicylal-N′-salicyloylhydrazine, N,N′-bis(salicyloyl)hydrazine, N,N′-bis(3,5-di-tertbutyl-4-hydroxyphenylpropionyl)hydrazine, 3-salicyloylamino-1,2,4-triazole, bis(benzylidene)oxalyl dihydrazide, oxanilide, isophthaloyl dihydrazide, sebacoylbisphenyl hydrazide, N,N′-diacetyladipic dihydrazide, N,N′-bis(salicyloyl)oxalic dihydrazide, and N,N′-bis(salicyloyl)thiopropionyl dihydrazide.

Group l) of the phosphites and phosphonites includes for example triphenyl phosphite, diphenyl alkyl phosphites, phenyl dialkyl phosphites, tris(nonylphenyl) phosphite, trilauryl phosphite, trioctadecyl phosphite, distearyl pentaerythritol diphosphite, tris(2,4-di-tert-butylphenyl) phosphite, diisodecyl pentaerythritol diphosphite, bis(2,4-di-tert-butylphenyl) pentaerythritol diphosphite, bis(2,6-di-tert-butyl-4-methylphenyl) pentaerythritol diphosphite, diisodecyloxy pentaerythritol diphosphite, bis(2,4-di-tertbutyl-6-methylphenyl) pentaerythritol diphosphite, bis(2,4,6-tris(tert-butylphenyl) pentaerythritol diphosphite, tristearyl sorbitol triphosphite, tetrakis(2,4-di-tertbutylphenyl) 4,4′-biphenylenediphosphonite, 6-isooctyloxy-2,4,8,10-tetra-tert-butyldibenzo[d,f][1,3,2]dioxaphosphepine, 6-fluoro-2,4,8,10-tetra-tert-butyl-12-methyldibenzo[d,g][1,3,2]dioxaphosphocine, bis(2,4-di-tert-butyl-6-methylphenyl)methyl phosphite, bis(2,4-di-tert-butyl-6-methylphenyl)ethyl phosphite, 2,2′,2″-nitrilo[triethyl tris(3,3′,5,5′-tetra-tert-butyl-1,1′-biphenyl-2,2′-diyl)phosphite], and 2-ethylhexyl 3,3′,5,5′-tetra-tert-butyl-1,1′-biphenyl-2,2′-diyl phosphite.

Group m) of the hydroxylamines includes for example N,N-dibenzylhydroxylamine, N,N-diethylhydroxylamine, N,N-dioctylhydroxylamine, N,N-dilaurylhydroxylamine, N,N-ditetradecylhydroxylamine, N,N-dihexadecylhydroxylamine, N,N-dioctadecylhydroxylamine, N-hexadecyl-N-octadecylhydroxylamine, N-heptadecyl-N-octadecylhydroxylamine, N-methyl-N-octadecylhydroxylamine, and N,N-dialkylhydroxylamine from hydrogenated tallow fatty amines.

Group n) of the nitrones includes for example N-benzyl α-phenyl nitrone, N-ethyl α-methyl nitrone, N-octyl α-heptyl nitrone, N-lauryl α-undecyl nitrone, N-tetradecyl α-tridecyl nitrone, N-hexadecyl α-pentadecyl nitrone, N-octadecyl α-heptadecyl nitrone, N-hexadecyl α-heptadecyl nitrone, N-octadecyl α-pentadecyl nitrone, N-heptadecyl α-heptadecyl nitrone, N-octadecyl α-hexadecyl nitrone, N-methyl α-heptadecyl nitrone, and nitrones derived from N,N-dialkylhydroxylamines prepared from hydrogenated tallow fatty amines.

Group o) of the amine oxides includes for example amine oxide derivatives as described in U.S. Pat. Nos. 5,844,029 and 5,880,191, didecylmethylamine oxide, tridecylamine oxide, tridodecylamine oxide and trihexadecylamine oxide.

Group p) of the benzofuranones and indolinones includes for example those described in U.S. Pat. Nos. 4,325,863; 4,338,244; 5,175,312; 5,216,052; 5,252,643; in DE-A-4316611; in DE-A-4316622; in DE-A-4316876; in EP-A-0589839 or EP-A-0591102, or 3-[4-(2-acetoxyethoxy)phenyl]-5,7-di-tert-butylbenzofuran-2(3H)one, 5,7-di-tert-butyl-3-[4-(2-stearoyloxyethoxy)phenyl]benzofuran-2(3H)-one, 3,3′-bis[5,7-di-tert-butyl-3-(4-[2-hydroxyethoxy]phenyl)benzofuran-2(3H)-one], 5,7-di-tertbutyl-3-(4-ethoxyphenyl)benzofuran-2(3H)-one, 3-(4-acetoxy-3,5-dimethylphenyl)-5,7-di-tert-butyl-benzofuran-2(3H)-one, 3-(3,5-dimethyl-4-pivaloyloxyphenyl)-5,7-di-tertbutyl-benzofuran-2(3H)-one, 3-(3,4-dimethylphenyl)-5,7-di-tert-butyl-benzofuran-2(3H)one, Irganox® HP-136 from Ciba Specialty Chemicals, and 3-(2,3-dimethylphenyl)-5,7-di-tert-butyl-benzofuran-2(3H)-one.

Group q) of the thiosynergists includes for example dilauryl thiodipropionate or distearyl thiodipropionate.

Group r) of the peroxide scavengers includes for example esters of β-thiodipropionic acid, for example, the lauryl, stearyl, myristyl or tridecyl ester, mercaptobenzimidazole or the zinc salt of 2-mercaptobenzimidazole, zinc dibutyldithiocarbamate, dioctadecyl disulfide, and pentaerythritol tetrakis(β-dodecylmercapto)propionate.

Group s) of the basic costabilizers includes for example melamine, polyvinylpyrrolidone, dicyandiamide, triallylcyanurate, urea derivatives, hydrazine derivatives, amines, polyamides, polyurethanes, alkali metal and alkaline earth metal salts of higher fatty acids, for example, calcium stearate, zinc stearate, magnesium behenate, magnesium stearate, sodium ricinoleate, and potassium palmitate, antimony pyrocatecholate or zinc pyrocatecholate.

Suitable further light stabilizers include, in particular, diphenylcyanoacrylates such as ethyl 2-cyano-3,3-diphenylacrylate. A further preferred embodiment of the present invention relates, therefore, to a composition wherein the compound of the formula (I) is N,N′-bis(formyl)-N,N′-bis(2,2,6,6-tetramethyl-4-piperidyl)-1,6 hexanediamine and the further light stabilizer is ethyl 2-cyano-3,3-diphenylacrylate. The weight ratio of compound of formula (I) to ethyl 2-cyano-3,3-diphenylacrylate is typically then in the range from 10:1 to 1:10, preferably in the range from 5:1 to 1:5.

Also particularly suitable as further light stabilizer are sterically hindered amines. Very particular preference is given to polymer-analogous reaction products of 4-amino-2,2,6,6-tetramethylpiperidine and maleic acid/C₂₀-C₂₄ α-olefin copolymers, an example being Uvinul® 5050H (BASF Aktiengesellschaft, Ludwigshafen, Germany) and the corresponding polymer-analogous reaction products with 4-amino-1,2,2,6,6-pentamethylpiperidine (e.g., “methylated Uvinul® 5050H”). A further preferred embodiment of the present invention relates, therefore, to a composition in which the compound of the formula (I) is N,N′-bis(formyl)-N,N′-bis(2,2,6,6-tetramethyl-4-piperidyl)-1,6 hexanediamine and as further light stabilizer the polymer-analogous reaction products of 4-amino-2,2,6,6-tetramethylpiperidine and maleic acid/C₂₀-C₂₄ α-olefin copolymers or the corresponding product methylated on the piperidine nitrogen atom. The weight ratio of compound of the formula (I) to the polymer-analogous reaction products of 4-amino-2,2,6,6-tetramethylpiperidine and maleic acid/C₂₀-C₂₄ α-olefin copolymers, or the corresponding product methylated on the piperidine nitrogen atom, is typically then in the range from 10:1 to 1:10, preferably in the range from 5:1 to 1:5.

In accordance with the invention the composition may also comprise at least one additive selected from antistatic agents, fillers or reinforcing agents, and nucleating agents (group t).

Examples of suitable antistatic agents include amine derivatives such as N,N-bis(hydroxyalkyl)alkylamines or -alkylenamines, polyethylene glycol esters and ethers, ethoxylated carboxylic esters and carboxamides, and glycerol monostearates and distearates, and also mixtures thereof.

Suitable fillers or reinforcing agents comprise, for example, the pigments already mentioned above, such as carbon black, graphite, calcium carbonate, silicates, talc, mica, kaolin, barium sulfate, metal oxides and metal hydroxides, wood flour and fine powders or fibers of other natural products, and synthetic fibers. Examples of suitable fibrous or pulverulent fillers further include carbon fibers or glass fibers in the form of glass fabrics, glass mats or filament glass rovings, chopped glass, glass beads, and wollastonite. Glass fibers can be incorporated both in the form of short glass fibers and in the form of continuous fibers (rovings).

The composition of the invention may further comprise nucleating agents as well. The suitable nucleating agents include, for example, inorganic materials, such as talc, metal oxides such as titanium oxide or magnesium oxide, phosphates, carbonates or sulfates of preferably alkaline earth metals; organic compounds such as monocarboxylic or polycarboxylic acids and also their salts, such as 4-tert-butylbenzoic acid, adipic acid, diphenylacetic acid, sodium succinate or sodium benzoate; polymeric compounds, such as ionic copolymers (“ionomers”), for example.

The compounds from groups a) to s), with the exception of the benzofuranones of group p), are used in typical amounts, in amounts for example of 0.0001% to 10% by weight, preferably 0.01% to 1% by weight, based on the total weight of the composition. The additives of the group t) are used in the typical amounts. Typically they are used in an amount of 0 to 60% by weight, based on the total weight of the composition.

In one specific embodiment the pigments employed in pigmented polymer compositions are in finely divided form, i.e., they typically have an average primary-particle size of less than 5 μm (5000 nm). Finely divided pigments, however, tend to amalgamate and form agglomerates. When the pigments are processed in the polymer it is necessary to disrupt the pigment agglomerates by means of shearing forces, in order to ensure fine division. To assist this operation it is customary to add dispersing assistants.

Dispersing assistants typically employed in pigmented polymer compositions are polyethylene waxes and polypropylene waxes, metal soaps, fatty acid esters, montan acid wax, waxlike polymers or amide wax. Very generally there is a need to minimize the proportion of dispersing assistant.

One widespread method of further processing of thermoplastics is the melt spinning process. In that process the polymer composition, either directly from production or after melting in an extruder, is forced through spinneret dies, each die being composed, for example, of a perforated plate drilled with numerous holes. The polymer melt emerges from the holes in the die as a bundle of filaments. In the spinning of conventional polymer compositions comprising, say, wax as dispersing assistant, however, the wax migrates from the polymer melt, with the consequence that wax deposits form around the dies. The melt spinning line must be shut down and cleaned, which of course is expensive. Furthermore, the migrated wax is deposited on the fiber, which as a result is more difficult to print, for example, in a downstream processing operation. The waxes employed as dispersing assistants in conventional pigmented polymer compositions are therefore disadvantageous, for the reasons set out above. In the dry spinning and wet spinning process as well it is a disadvantage for the polymer composition to comprise wax dispersing assistants.

In the light of the prior art it was surprising and unforeseeable for the skilled worker that the compound of the formula (I) had the capacity to act as a dispersing assistant in a pigmented polymer composition. Such an effect is not exhibited by the prior-art stabilizers against exposure to light, oxygen and/or heat.

The present invention therefore further provides a process for producing a pigmented polymer composition comprising a continuous polymer phase and, dispersed therein, a particulate pigment phase, which comprises intimately contacting the polymer composition with the pigment and using as dispersing assistant at least one piperidine compound of the formula (I)

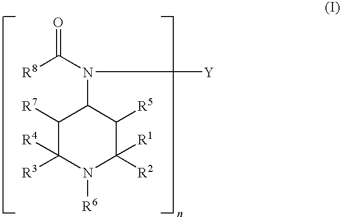

in which n, Y, R¹, R², R³, R⁴, R⁵, R⁶, R⁷, and R⁸ are as defined above, and in particular are as defined above as being preferred.

With regard to suitable polymers in the polymer composition, reference is made, in its entirety, to what was said above in connection with component ii). The polymer composition obtained by the process of the invention comprises as its polymer component preferably a polymer which can be processed further by injection molding, extrusion or blow molding. The pigmented polymer composition produced by the process of the invention is processed further by, in particular, the melt spinning process, dry spinning process or wet spinning process, especially by the melt spinning process.

The polymer component ii) is preferably selected from the group of polyolefins, polyolefin copolymers, polytetrafluoroethylenes, ethylene-tetrafluoroethylene copolymers, polyvinyl chlorides, polyvinylidene chlorides, polyvinyl alcohols, polyvinyl esters, polyvinylalkanals, polyvinylketals, polyamides, polyimides, polycarbonates, polycarbonate blends, polyesters, polyester blends, poly(meth)acrylates, poly(meth)acrylate-styrene copolymer blends, poly(meth)acrylate-polyvinylidene difluoride blends, polyurethanes, polystyrenes, styrene copolymers, polyethers, polyether ketones, and polysulfones, and mixtures thereof.

The polymer component ii) is preferably selected from the group of polyolefins, polyolefin copolymers, polyvinylalkanals, polyamides, polycarbonates, polycarbonatepolyester blends, polycarbonate-styrene copolymer blends, polyesters, polyester blends, poly(meth)acrylates, poly(meth)acrylate-styrene copolymer blends, poly(meth)acrylate-polyvinylidene difluoride blends, styrene copolymers and polysulfones, and mixtures thereof.

With particular preference the polymer component ii) is selected from polypropylene, polyamide 6, polyamide 6,6, polycarbonate, polycarbonate-polyethylene terephthalate blends, polycarbonate-polybutylene terephthalate blends, polycarbonateacrylonitrile/styrene/acrylonitrile copolymer blends, polycarbonate-acrylonitrile/butadiene/styrene copolymer blends, methyl methacrylate-acrylonitrile/butadiene/styrene polymer (MABS), polyethylene terephthalate, polybutylene terephthalate, polymethyl methacrylate, impact-modified polymethyl methacrylate, polybutyl acrylate, polymethyl methacrylate-polyvinylidene difluoride blends, acrylonitrile/butadiene/styrene copolymers (ABS), acrylonitrile/styrene/acrylic ester polymers (ASA), styrene/acrylonitrile copolymers (SAN), and polyphenylene sulfone, and also mixtures thereof.

With regard to suitable and preferred pigments reference is made, in its entirety, to what was said above in connection with the pigment component iii).

A pigmented polymer composition comprising a continuous polymer phase and, dispersed therein, a particulate pigment phase is prepared by intimately mixing polymer component, pigment, and piperidine compound of the formula (I). Examples of mixing equipment for implementing the process of the invention include heated internal kneaders with or without rams, operating in batch mode; continuously operating kneaders such as continuous internal kneaders, or screw kneaders with axially oscillating screws, and Banbury kneaders; and, moreover, extruders, and also roll mills, roll mixers with heated rolls, and calenders.

The typical types of extruder known to the skilled worker are suitable in principle for these purposes. Such extruders typically comprise a barrel, a drive unit, a plastifying unit composed of one or more rotating axles (screws) provided with conveying elements and/or kneading elements, and a control unit. Extending along the screw in the conveying direction there are two or more zones, which in the process of the invention comprise an intake zone, at least one zone for plastifying and homogenizing, and a discharge zone. Each zone may comprise in turn one or more barrels as the smallest independent unit. Examples of suitable extruders are single-screw extruders, twin-screw extruders, and multiscrew extruders. In one preferred version a twin-screw extruder is used.

The polymer component can be supplied in melted form, but generally in solid form, to the mixing apparatus used in accordance with the invention. If the polymer component is used in solid form then it may take the form of granules, powder, pellets or grindstock. In that case the polymer component is melted at temperatures of 150 to 300° C., for example.

The pigment can be used without adjuvant, in solid form for example. Preferably, though, the pigment is employed in the form of a masterbatch product.

The polymer component, the pigment, the piperidine compound, and any further additives can also be mixed “cold” and the mixture thereafter is melted and homogenized. Suitable temperatures are located typically in the range from 150 to 300° C.

The order in which polymer component, pigment, and piperidine compound of the formula (I) are added is not critical. The addition may be made together or separately from one another, all at once or in portions. If appropriate it may be of advantage to use premixes of pigment component and piperidine compound of the formula (I). The intimate contacting may also take place in the presence of at least one additive, selected from an antioxidant, light stabilizer, metal deactivator, antistatic agent, reinforcing agent, filler, antifogging agent, biocide, and dispersing assistant other than the compounds of the formula (I). With respect to suitable antioxidants, light stabilizers, metal deactivators, antistatic agents, reinforcing agents, fillers, antifogging agents, and biocides, reference is hereby made, in its entirety, to what was said above. Suitable dispersing assistants other than the compound of formula (I) are polyethylene wax, polypropylene wax, metal soaps, fatty acid esters, montan acid, waxlike polymers, and amide wax. The fraction of the dispersing assistant other than the compound of the formula (I) is preferably less than 0.01% by weight, based on the total weight of the polymer composition. In one particularly preferred embodiment of the present invention the colorant-comprising polymer composition comprises no further dispersing assistant other than the compound of the formula (I), and in particular no wax.

Owing to the process of the invention the pigment is in particulate form in the continuous polymer phase. Agglomeration and/or sedimentation of the pigment takes place not at all or only to a minor extent. A pigmented polymer composition prepared by the process of the invention does not have the aforementioned disadvantages of a conventional pigmented polymer composition.

The present invention accordingly further provides for the use of a piperidine compound of the formula (I) as a dispersing assistant for pigments in polymer compositions.

The inventive use of a piperidine compound of the formula (I) therefore affords a series of advantages:

The piperidine compound of the formula (I) is able to disperse pigments very effectively in polymer compositions. It is therefore possible in general to do without the use of a dispersing assistant other than the compound I, and in particular of the use of wax as a dispersing assistant. When using a dispersing assistant other than the compound of the formula (I) its proportion is below 0.01% by weight, based on the total weight of the colorant-comprising polymer composition. In one particularly preferred embodiment of the invention no dispersing assistant other than the compound of the formula (I) is used.

The color strength of a pigmented polymer composition is dependent on the degree of colorant dispersion attained. The more finely divided the pigment, the deeper the apparent color of the colored polymer. In contrast to prior-art stabilizers against exposure to light, oxygen and/or heat, the piperidine compound of the formula (I) is capable of dispersing pigments very effectively in polymer compositions. A lower pigment content, therefore, is needed in order to obtain the same color strength, as compared with a conventional pigmented polymer composition comprising a prior-art stabilizer against exposure to light, oxygen and/or heat.

### Performance Investigations

### Stabilizers Used:

S1: Uvinul® 4050H from BASF Aktiengesellschaft, Ludwigshafen, Germany (N,N′-bis(formyl)-N,N′-bis(2,2,6,6-tetramethyl-4-piperidyl)-1,6-hexanediamine), CAS No. 124172-53-8;
S3: Uvinul® 3035 from BASF Aktiengesellschaft, Ludwigshafen, Germany, ethyl 2-cyano-3,3-diphenylacrylate, CAS No. 5232-99-5;
S4: Tinuvin® 234 from Ciba Specialty Chemicals, Switzerland, 2-(2H-benzotriazol-2-yl)-4,6-bis(1-methyl-1-phenylethyl)phenol, CAS No. 70321-86-7;
S5: Tinuvin® 320 from Ciba Specialty Chemicals, Switzerland, 2-(2H-hydroxy-3,5-di-tert-butylphenyl)benzotriazole), CAS No. 3864-71-7;
S6: Tinuvin® 770 from Ciba Specialty Chemicals, Switzerland, bis(2,2,6,6-tetramethyl-4-piperidinyl) sebacate), CAS No. 52829-07-9;
S7: Tinuvin® 783 from Ciba Specialty Chemicals, Switzerland, mixture of poly{[6-[(1,1,3,3-tetramethylbutyl)imino]-1,3,5-triazine-2,4-diyl]-[2-(2,2,6,6-tetramethylpiperidyl)amino]hexamethylene-[4-(2,2,6,6-tetramethylpiperidyl)imino]} and poly-(N-1-hydroxyethyl-2,2,6,6-tetramethyl-4-hydroxypiperidyl succinate);
S8: Tinuvin® P, 2-(2-hydroxy-5-methylphenyl)benzotriazole), from Ciba Specialty Chemicals, Switzerland, CAS No. 2440-22-4;
S9: Chimassorb® 2020 from Ciba Specialty Chemicals, Switzerland, 1,6-hexanediamine, N,N′-bis(2,2,6,6-tetramethyl-4-piperidinyl)-, polymer with 2,4,6-trichloro-1,3,5-triazine, reaction product with N-butyl-1-butanamine and N-butyl-2,2,6,6-tetramethyl-4-piperidinamine), CAS No. 192268-64-7;
S10: Chimassorb® 944 from Ciba Specialty Chemicals, Switzerland, poly[[6-[(1,1,3,3-tetramethylbutyl)amino]-1,3,5-triazine-2,4-diyl]-[(2,2,6,6-tetramethyl-4-piperidinyl)imino]-1,6-hexanediyl[2,2,6,6-tetramethyl-4-piperidinyl)imino]], CAS No. 71878-19-8;
S11: Cyasorb® 3346 from Cytec, USA, poly[[6-(morpholino)-s-triazine-2,4-diyl][(2,2,6,6-tetramethyl-4-piperidyl)imino]hexamethylene [(2,2,6,6-tetramethyl-4-piperidyl)imino]]), CAS No. 082451-48-7;
S12: Cyasorb® 3529 from Cytec, USA, 1,6-hexanediamine, N,N′-bis(2,2,6,6-tetramethyl-4-piperidinyl)-, polymer with morpholino-2,4,6-trichloro-1,3,5-triazine, CAS No. 193098-40-7
S13: Cyasorb® 3853 from Cytec, USA, CAS No. 167078-06-0

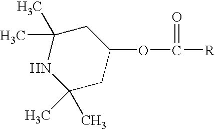

R=C₁₁-C₂₀, preferably C₁₆-C₁₈
S14: Hostavin® N 30 from Clariant, Frankfurt/Main, Germany, polymer of 2,2,4,4-tetramethyl-7-oxa-3,20-diazadispiro[5.1.11.2]heneicosan-21-one and epichlorohydrin, CAS No. 202483-55-4;
S15: Irganox® 1098 from Ciba Specialty Chemicals, Switzerland, phenylpropanamide-N,N-1,6-hexanediylbis[3,5-bis(1,1-dimethylethyl)-4-hydroxy], CAS-Nr.: 23128-74-7.

### EXAMPLE 1

### Exposure and Oven Storage of White-Pigmented ABS

In an intensive mixer 0.5% by weight of S1, 0.35% by weight of S3, ABS of Terluran 967K type (BASF Aktiengesellschaft, Ludwigshafen, Germany) and 1.0% by weight of TiO₂, based on the weight of the mixture as a whole, were mixed and subsequently homogenized by a laboratory extruder at a temperature of 240° C., and granulated. The granules obtained were injection-molded to form test specimens 2 mm thick.

These test specimens were exposed in accordance with DIN 54004 at 45° C. (Table 1) or stored in accordance with DIN 53383 in a forced-air oven at 90° C. (Table 2). Measurements were made of the yellowing (Yellowness Index, YI) after 0, 500, 1000, 1500, and 2000 hours of exposure and, respectively, after 0, 250, 500, and 750 hours of oven storage.

The control used was a test specimen produced as described above in Example 1 but containing no added stabilizer mixture. As a comparative a test specimen was used which was produced as described above in Example 1 but with a stabilizer mixture which consisted, in contrast to Example 1, of 0.5% by weight of S6 and 0.5% by weight of S8 instead of 0.5% by weight of S1 and 0.35% by weight of S3.

TABLE 1
Exposure of white-pigmented ABS at 45° C.

| | YI after hours of exposure | | | | |
|---|---|---|---|---|---|
| Stabilizer mixture | 0 h | 500 h | 1000 h | 1500 h | 2000 h |
| Unstabilized | 17.3 | 16.9 | 19.7 | 18 | 24 |
| 0.5% by weight S1 | 18 | 9.1 | 9.8 | 8.5 | 9.2 |
| 0.35% by weight S3 | | | | | |
| 0.5% by weight S6 | 18.4 | 11.9 | 12 | 9.8 | 10.1 |
| 0.5% by weight S8 | | | | | |

TABLE 2
Oven storage of white-pigmented ABS at 90° C.

YI after hours

| Stabilizer mixture | 0 h | 250 h | 500 h | 750 h |
|---|---|---|---|---|
| 0.5% by weight S1 | 18 | 21.5 | 19.9 | 22 |
| 0.35% by weight S3 | | | | |
| 0.5% by weight S6 | 18.4 | 22.9 | 25.1 | 26.8 |
| 0.5% by weight S8 | | | | |

The YI is a measure of the damage to the polymer. The smaller the YI figure, the better the effect of the stabilizer. As is apparent from Tables 1 and 2, the stabilizer combination of S1 (N,N′-bis(formyl)-N,N′-bis(2,2,6,6-tetramethyl-4-piperidyl)-1,6-hexanediamine) and S3 (ethyl 2-cyano-3,3-diphenylacrylate) is superior to the stabilizer combination of S6 (bis(2,2,6,6-tetramethyl-4-piperidinyl) sebacate) and S8 (2-(2-hydroxy-5-methylphenyl)benzotriazole) both on exposure at 45° C. and on oven storage at 90° C. With a stabilizer combination comprising S1 (N,N′-bis(formyl)-N,N′-bis(2,2,6,6-tetramethyl-4-piperidyl)-1,6-hexanediamine) and S3 (ethyl 2-cyano-3,3-diphenylacrylate) a longer period of stabilization is achieved.

### EXAMPLE 2

### Oven Storage of Gray-Pigmented ABS

Example 1 was repeated but using 2.0% by weight of Sicostyren Gray 00-6295 in place of 1% by weight of TiO₂. Measurements were made of the yellowing (Yellowness Index, YI) after 200, 400, 600, 800, and 1000 h of oven storage.

TABLE 3
Oven storage of gray-pigmented ABS at 90° C.

| | YI after hours | | | | |
|---|---|---|---|---|---|
| Stabilizer mixture | 200 h | 400 h | 600 h | 800 h | 1000 h |
| 0.5% by weight S1 | 0.2 | 0.4 | 0.7 | 1.1 | 1.5 |
| 0.35% by weight S3 | | | | | |
| 0.5% by weight S6 | 0.3 | 0.5 | 1 | 1.5 | 1.7 |
| 0.5% by weight S8 | | | | | |

### EXAMPLE 3

### Color Equivalents and Residual Tensile Strength of Pigmented Polypropylene Fiber

Basel HP 561 R (polypropylene from Basell, Netherlands) was mixed in an intensive mixer with the stabilizers and pigments indicated in Tables 4 and 5 and the mixture was homogenized by a laboratory extruder at a temperature of 182° C. and spun via a fiber unit. The fibers thus produced were investigated for their color equivalents and residual tensile strength.

The control used was a polypropylene fiber comprising as pigment 0.3% by weight of Paliotol yellow K 1841 or 0.3% by weight of PV Fast Yellow HR.

For comparison the following stabilizers were used: S7; S9; S10; S11; S12; and S13.

TABLE 4
Color equivalents of pigmented polypropylene fiber

| Stabilizer/pigment mixture | CE |
|---|---|
| 0.3% by weight Paliotol yellow K1841 (control) | 100 |
| 0.3% by weight PV Fast Yellow HR (control) | 100 |
| 0.2% by weight S1 | 50 |
| 0.3% by weight Paliotol yellow K1841 | |
| 0.2% by weight S9, | 99 |
| 0.3% by weight Paliotol yellow K1841 | |
| 0.2% by weight S7 | 158 |
| 0.3% by weight Paliotol yellow K1841 | |
| 0.2% by weight S10 | 107 |
| 0.3% by weight Paliotol yellow K1841 | |
| 0.2% by weight S11 | 129 |
| 0.3% by weight Paliotol yellow K1841 | |
| 0.2% by weight S12 | 150 |
| 0.3% by weight Paliotol yellow K1841 | |
| 0.2% by weight S13 | 123 |
| 0.3% by weight Paliotol yellow K1841 | |
| 0.2% by weight S1 | 81 |
| 0.3% by weight PV Fast Yellow HR | |
| 0.2% by weight S9, | 95 |
| 0.3% by weight PV Fast Yellow HR | |
| 0.2% by weight S7 | 162 |
| 0.3% by weight PV Fast Yellow HR | |
| 0.2% by weight S10 | 110 |
| 0.3% by weight PV Fast Yellow HR | |
| 0.2% by weight S11 | 144 |
| 0.3% by weight Fast Yellow HR | |
| 0.2% by weight S12 | 118 |
| 0.3% by weight PV Fast Yellow HR | |

The color equivalent (CE) indicates relative to the control value of 100 (for pigmented polypropylene without stabilizer or dispersing assistant) the number of parts of pigment required to obtain the same color effect. The smaller the CE figure, the better the effect of the stabilizer and/or dispersing assistant. In terms of color equivalents, S1 shows significantly better values for Paliotol yellow K1841 and PV Fast Yellow HR than do the other stabilizers investigated.

TABLE 5
Residual tensile strength of pigmented polypropylene fiber

| | Residual tensile strength after hours of weathering | | | | | |
|---|---|---|---|---|---|---|
| Stabilizer/pigment mixture | 500 h | 1000 h | 1500 h | 2000 h | 2500 h | 3000 h |
| 0.3% by weight Paliotol yellow K1841 | 53% | brittle | | | | |
| 0.3% by weight Paliotol yellow 0961 | 21% | brittle | | | | |
| 0.2% by weight S1 | 84% | 78% | 75% | 68% | 70% | 54% |
| 0.3% by weight Paliotol yellow K1841 | | | | | | |
| 0.2% by weight S9, | 78% | 70% | 63% | 58% | 49% | brittle |
| 0.3% by weight Paliotol yellow K1841 | | | | | | |
| 0.2% by weight S7 | 87% | 74% | 63% | 65% | 60% | 52% |
| 0.3% by weight PV Fast Yellow HR | | | | | | |
| 0.2% by weight S10 | 82% | 71% | 66% | 59% | 44% | 39% |
| 0.3% by weight Paliotol yellow K1841 | | | | | | |
| 0.2% by weight S11 | 73% | 70% | 56% | 47% | brittle | |
| 0.3% by weight Paliotol yellow K1841 | | | | | | |
| 0.2% by weight S12 | 75% | 66% | 54% | 48% | brittle | |
| 0.3% by weight Paliotol yellow K1841 | | | | | | |
| 0.2% by weight S13 | 81% | 73% | 66% | 48% | brittle | |
| 0.3% by weight Paliotol yellow K1841 | | | | | | |
| 0.2% by weight S14 | 76% | 59% | 55% | 30% | brittle | 76% |
| 0.3% by weight Paliotol yellow K1841 | | | | | | |
| 0.2% by weight S1 | 50% | 14% | | | | |
| 0.3% by weight Paliotol yellow 0961 | | | | | | |
| 0.2% by weight S9, | 41% | brittle | | | | |
| 0.3% by weight Paliotol yellow 0961 | | | | | | |
| 0.2% by weight S7 | 70% | 10% | | | | |
| 0.3% by weight Paliotol yellow 0961 | | | | | | |
| 0.2% by weight S10 | 55% | brittle | | | | |
| 0.3% by weight Paliotol yellow 0961 | | | | | | |
| 0.2% by weight S11 | 52% | brittle | | | | |
| 0.3% by weight Paliotol yellow 0961 | | | | | | |
| 0.2% by weight S12 | 53% | brittle | | | | |
| 0.3% by weight Paliotol yellow 0961 | | | | | | |
| 0.2% by weight S13 | brittle | | | | | |
| 0.3% by weight Paliotol yellow 0961 | | | | | | |
| 0.2% by weight S14 | 46% | brittle | | | | |
| 0.3% by weight Paliotol yellow 0961 | | | | | | |

The residual tensile strength cited indicates the proportion of the force required to break a fiber after the fiber has been weathered for 500, 1000, 1500, 2000, 2500, and 3000 h in accordance with DIN EN ISO 4892-2. The initial figure (0 h weathering) is set at 100%, as a control. The greater the residual tensile strength, the better the effect of the stabilizer.

As is apparent from Table 5, S1 (N,N′-bis(formyl)-N,N′-bis(2,2,6,6-tetramethyl-4-piperidyl)-1,6-hexanediamine) in terms of residual tensile strength exhibits significantly better values for Paliotol yellow K1841 than do the other stabilizers investigated.

### EXAMPLE 4

### Residual Tensile Strength of Pigmented Polyamide Fiber

Polyamide Ultramid B3S (yarn 1360 f 68) (BASF Aktiengesellschaft, Ludwigshafen, Germany) was mixed in an intensive mixer with the stabilizers indicated in Table 6 and with in each case 1.0% by weight of Palamid Yellow 21-0705 and in each case 0.85% by weight of Ultramid PC1 (BASF Aktiengesellschaft, Ludwigshafen, Germany) and the mixture was homogenized via a laboratory extruder at a temperature of 260° C. and spun via a fiber unit. The yarns produced in this way were investigated for their residual tensile strength.

TABLE 6
Residual tensile strength of pigmented polyamide fiber

| | Residual tensile strength after cycles of exposure | | | | |
|---|---|---|---|---|---|
| | 2nd | 4th | 6th | 8th | 10th |
| Stabilizer mixture | cycle | cycle | cycle | cycle | cycle |
| Unstabilized | 0% | | | | |
| 0.2% by weight S1 | 91% | 84% | 82% | 73% | 72% |
| 0.1% by weight S4 | 77% | 74% | 52% | 37% | 21% |
| 0.2% by weight S10 | | | | | |

The residual tensile strength reported indicates the proportion of the force required to break the fiber after it has been exposed in accordance with DIN 75 202-3 A10. The initial figure (0 exposure cycles) is set at 100%, as a control. The greater the residual tensile strength, the better the effect of the stabilizer.

### EXAMPLE 5

### Color Change in Pigmented Thick-Walled Polyamide

Polyamide 6 of the type Ultramid B3S (BASF Aktiengesellschaft, Ludwigshafen, Germany) was mixed in an intensive mixer with the stabilizers and pigments listed in Tables 7 and 8 and the mixture was homogenized via a laboratory extruder at a temperature of 261° C. and granulated. The granules obtained were injection molded to give test plaques with a thickness of 3 or 2 mm. These plaques were exposed in accordance with DIN 75202-3 at 100° C. (Table 7) or weathered in accordance with DIN 53387 at 65° C. (Table 8).

The parameter measured in each case was the color change (DE*(CIELAB)) after 1, 2, 3, 4, and 5 exposure cycles or after 1000, 1500, 2000, 2300, 2500, and 3000 h of weathering. The DE*(CIELAB) figure represents a measure of the efficacy of the stabilizer. The lower this figure, the better the effect of the stabilizer.

TABLE 7
Color change on exposure of pigmented thick-walled polyamide

| | DE*(CIELAB) after cycles of exposure | | | | |
|---|---|---|---|---|---|
| | 1st | 2nd | 3rd | 4th | 5th |
| Stabilizer/pigment mixture | cycle | cycle | cycle | cycle | cycle |
| 0.2% by weight S6 | 0.4 | 1.4 | 1.9 | 2.2 | 3.3 |
| 1.0% by weight Sicoversal-Gray | | | | | |
| 22/24000 | | | | | |
| 0.2% by weight S1 | 0.2 | 0.5 | 1 | 1.3 | 1.6 |
| 1.0% by weight Sicoversal-Gray | | | | | |
| 22/24000 | | | | | |
| 0.2% by weight S6 | 0.5 | 1.2 | 1.8 | 2.4 | 3.4 |
| (glass fiber-reinforced) | | | | | |
| 1.0% by weight Sicoversal-Gray | | | | | |
| 22/24000 | | | | | |
| 0.2% by weight S1 | 0.2 | 0.5 | 1 | 1.3 | 1.6 |
| (glass fiber-reinforced) | | | | | |
| 1.0% by weight Sicoversal-Gray | | | | | |
| 22/24000 | | | | | |

As is apparent from Table 7, significantly better stabilization is obtained with S1 (N,N′-bis(formyl)-N,N′-bis(2,2,6,6-tetramethyl-4-piperidyl)-1,6-hexanediamine) than with S6 (bis(2,2,6,6-tetramethyl-4-piperidinyl) sebacate) when the stabilizer is employed in equal amount.

TABLE 8
Color change on weathering of blue-pigmented (1.0%
Sicopal Blue K 6310) thick-walled polyamide

| | DE*(CIELAB) after hours of weathering | | |
|---|---|---|---|
| Stabilizer | 1000 h | 2000 h | 3000 h |
| Unstabilized | 6.8 | 13.6 | 16.7 |
| 0.2% by weight S1 | 0.32 | 1.7 | 3.4 |
| 0.2% by weight S6 | 0.29 | 1.8 | 4.6 |

As is apparent from Table 8, significantly better stabilization is obtained with S1 (N,N′-bis(formyl)-N,N′-bis(2,2,6,6-tetramethyl-4-piperidyl)-1,6-hexanediamine) than with S6 (bis(2,2,6,6-tetramethyl-4-piperidinyl) sebacate) when the stabilizer is employed in equal amount.

1-40. (canceled)

41. A composition comprising:
i) as stabilizer at least one piperidine compound of the formula (I) 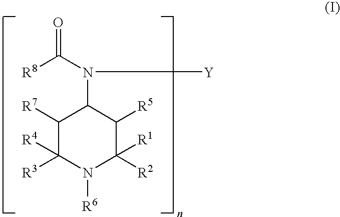
in which
n is 1 or 2;
R¹, R², R³, and R⁴ each independently are C₁-C₄-alkyl, or R¹ and R² and/or R³ and R⁴, together with the carbon atom to which they are attached, form a 4-, 5-, 6-, 7- or 8-membered ring;
R⁵ and R⁷ each independently are hydrogen or C₁-C₄-alkyl;
R⁶ is hydrogen, oxyl, hydroxyl, acyl, C₁-C₄₀-alkyl or C₂-C₄₀-alkenyl, it being possible for the two last-mentioned radicals to be interrupted by one or more nonadjacent groups selected independently of one another from oxygen, sulfur, —NH—, and N(C₁-C₁₀-alkyl)-, and/or to carry one or more substituents selected from cyano, hydroxyl, amino, and aryl, it being possible for aryl in turn to be substituted one or more times by C₁-C₄-alkyl, halogen, C₁-C₄-alkoxy, di(C₁-C₄-alkyl)amino, methylenedioxy or ethylenedioxy;
R⁸ is hydrogen or C₁-C₁₀-alkyl; and
if n is 1
Y is hydrogen or is C₁-C₂₂-alkyl which is unsubstituted or is substituted one or more times by identical or different radicals R^{a} and may be interrupted by one or more nonadjacent groups selected independently of one another from oxygen, sulfur, —NH— and N(C₁-C₁₀-alkyl)-; or
Y is C₃-C₂₂-alkenyl, C₃-C₁₂-cycloalkyl, C₆-C₁₂-bicycloalkyl or C₃-C₁₀-cycloalkenyl, in which the four last-mentioned radicals may carry one or more radicals R^{a}, and C₃-C₁₂-cycloalkyl, C₆-C₁₂-bicycloalkyl, and C₃-C₁₀-cycloalkenyl additionally may carry one or more alkyl groups, or
Y is aryl, in which aryl may be substituted one or more times by halogen, C₁-C₄-alkyl, C₁-C₄-alkoxy, C₁-C₄-alkoxycarbonyl, methylenedioxy, ethylenedioxy or di-(C₁-C₄-alkyl)amino; or
Y is a heterocyclic ring which if appropriate carries one or more identical or different radicals selected from oxyl, hydroxyl, acyl, C₁-C₄₀-alkyl or C₂-C₄₀-alkenyl, it being possible for C₁-C₄₀-alkyl and C₂-C₄₀-alkenyl to be interrupted by one or more nonadjacent groups selected independently of one another from oxygen, sulfur, —NH— and N(C₁-C₁₀-alkyl)-, and/or to carry one or more substituents selected independently of one another from cyano, hydroxyl, amino, and aryl, it being possible for aryl in turn to be substituted one or more times by C₁-C₄-alkyl, halogen, C₁-C₄-alkoxy, di(C₁-C₄-alkyl)amino, methylenedioxy or ethylenedioxy;
R^{a} being cyano, amino, hydroxyl, hydroxy-C₁-C₄-alkoxy, C₁-C₄-alkoxycarbonyl, aryl or heterocyclyl, it being possible for the two last-mentioned radicals in turn to be substituted one or more times by halogen, hydroxyl, C₁-C₄-alkyl, C₁-C₄-alkoxy, C₁-C₄-alkoxycarbonyl, methylenedioxy, ethylenedioxy or di(C₁-C₄-alkyl)amino;
and if n is 2
Y is a divalent group having 1 to 30 bridge atoms between the flanking bonds, the divalent group having structural units selected from alkylene, alkenylene, arylene, heterocyclylene and cycloalkylene, it being possible for alkylene and alkenylene to be interrupted one or more times by oxygen, sulfur, —NH— and —N(C₁-C₁₀-alkyl)-, and for arylene, heterocyclyl, and cycloalkylene to be substituted one or more times by C₁-C₄-alkyl;
ii) at least one polymer; and
iii) at least one colorant.

42. The composition according to claim 41, wherein R¹, R², R³ and R⁴ in formula I are each methyl and R⁵ and R⁷ are each hydrogen.

43. The composition according to claim 41 or 42, wherein R⁶ in formula I is hydrogen.

44. The composition according to claim 41, wherein R⁸ is H.

45. The composition according to claim 41, wherein in formula (I) n is 2 and Y is a 2- to 10-membered alkylene chain.

46. The composition according to claim 41, wherein the compound of the formula (I) is N,N′-bis(formyl)-N,N′-bis(2,2,6,6-tetramethyl-4-piperidyl)-1,6-hexanediamine.

47. The composition according to claim 41, wherein the polymer ii) is selected from
halogenated polymers and mixtures thereof,
homopolymers or copolymers of ethers and mixtures thereof,
polyacetals, copolymers of polyacetals with cyclic ethers, polyacetals modified with thermoplastic polyurethanes, with acrylates or with methyl acrylate/butadiene/stryene copolymers, and mixtures thereof,
polyaryl ethers, polyaryl sulfides, mixtures of polyaryl ethers with styrene polymers and polyamides, and mixtures thereof,
polyurethanes,
polyureas, polyamideimides, polyetherimides, polyesterimides, polyhydantoins, polybenzimidazoles, and mixtures thereof,
polyesters,
polycarbonates, polyestercarbonates, and mixtures thereof,
polysulfones, polyethersulfones, polyetherketones, and mixtures thereof,
synthetic resins,
natural polymers,
naturally occurring or synthetic organic materials prepared from pure monomeric compounds or mixtures of such compounds,
aqueous emulsions of natural or synthetic rubber,
polymers of monoolefins or diolefins with vinyl monomers and mixtures thereof,
polymers deriving from unsaturated alcohols and amines or from their acyl derivatives or acetals,
polymers deriving from α,β-unsaturated acids and their derivatives,
polyamides and copolyamides,
polystyrene, poly(p-methylstyrene), poly(α-methylstyrene), and copolymers of styrene or α-methylstyrene, and
polyolefins and mixtures thereof.

48. The composition according to claim 47, wherein copolymers of styrene are copolymers of styrene with acrylonitrile and butadiene and/or acrylic or methacrylic esters.

49. The composition according to claim 47, wherein the polymer ii) is selected from ethylene and propylene homopolymers and copolymers and mixtures thereof.

50. The composition according to claim 41, wherein the polymer ii) is a polymer blend.

51. The composition according to claim 41, wherein the colorant iii) is a pigment.

52. The composition according to claim 51, wherein the pigment is a white or black pigment.

53. The composition according to claim 41, further comprising at least one additive selected from antioxidants, light stabilizers, metal deactivators, antistatic agents, reinforcing agents, fillers, antifogging agents, and biocides.

54. The composition according to claim 53, wherein the light stabilizer is a 2-cyano-3,3-diphenylacrylic ester.

55. A process for producing a pigmented polymer composition comprising a continuous polymer phase and, dispersed therein, a particulate pigment phase, wherein the polymer composition is intimately contacted with the pigment and the dispersing assistant used is at least one piperidine compound of the formula (I) 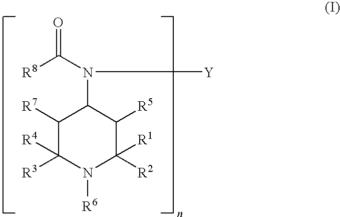
in which
n is 1 or 2;
R¹, R², R³, and R⁴ each independently are C₁-C₄-alkyl, or R¹ and R² and/or R³ and R⁴, together with the carbon atom to which they are attached, form a 4-, 5-, 6-, 7- or 8-membered ring;
R⁵ and R⁷ each independently are hydrogen or C₁-C₄-alkyl;
R⁶ is hydrogen, oxyl, hydroxyl, acyl, C₁-C₄₀-alkyl or C₂-C₄₀-alkenyl, it being possible for the two last-mentioned radicals to be interrupted by one or more nonadjacent groups selected independently of one another from oxygen, sulfur, —NH—, and N(C₁-C₁₀-alkyl)-, and/or to carry one or more substituents selected from cyano, hydroxyl, amino, and aryl, it being possible for aryl in turn to be substituted one or more times by C₁-C₄-alkyl, halogen, C₁-C₄-alkoxy, di(C₁-C₄-alkyl)amino, methylenedioxy or ethylenedioxy;
R⁸ is hydrogen or C₁-C₁₀-alkyl; and
if n is 1
Y is hydrogen or is C₁-C₂₂-alkyl which is unsubstituted or is substituted one or more times by identical or different radical R^{a} and may be interrupted by one or more nonadjacent groups selected independently of one another from oxygen, sulfur, —NH— and N(C₁-C₁₀-alkyl)-; or
Y is C₃-C₂₂-alkenyl, C₃-C₁₂-cycloalkyl, C₆-C₁₂-bicycloalkyl or C₃-C₁₀-cycloalkenyl, in which the four last-mentioned radicals may carry one or more radicals R^{a}, and C₃-C₁₂-cycloalkyl, C₆-C₁₂-bicycloalkyl, and C₃-C₁₀-cycloalkenyl additionally may carry one or more alkyl groups, or
Y is aryl, in which aryl may be substituted one or more times by halogen, C₁-C₄-alkyl, C₁-C₄-alkoxy, C₁-C₄-alkoxycarbonyl, methylenedioxy, ethylenedioxy or di-(C₁-C₄-alkyl)amino; or
Y is a heterocyclic ring which if appropriate carries one or more identical or different radicals selected from oxyl, hydroxyl, acyl, C₁-C₄₀-alkyl or C₂-C₄₀-alkenyl, it being possible for C₁-C₄₀-alkyl and C₂-C₄₀-alkenyl to be interrupted by one or more nonadjacent groups selected independently of one another from oxygen, sulfur, —NH— and N(C₁-C₁₀-alkyl)-, and/or to carry one or more substituents selected independently of one another from cyano, hydroxyl, amino, and aryl, it being possible for aryl in turn to be substituted one or more times by C₁-C₄-alkyl, halogen, C₁-C₄-alkoxy, di(C₁-C₄-alkyl)amino, methylenedioxy or ethylenedioxy;
R^{a} being cyano, amino, hydroxyl, hydroxy-C₁-C₄-alkoxy, C₁-C₄-alkoxycarbonyl, aryl or heterocyclyl, it being possible for the two last-mentioned radicals in turn to be substituted one or more times by halogen, hydroxyl, C₁-C₄-alkyl, C₁-C₄-alkoxy, C₁-C₄-alkoxycarbonyl, methylenedioxy, ethylenedioxy or di(C₁-C₄-alkyl)amino;
and if n is 2
Y is a divalent group having 1 to 30 bridge atoms between the flanking bonds, the divalent group having structural units selected from alkylene, alkenylene, arylene, heterocyclyl and cycloalkylene, it being possible for alkylene and alkenylene to be interrupted one or more times by oxygen, sulfur, —NH— and —N(C₁-C₁₀-alkyl)-, and for arylene, heterocyclyl, and cycloalkylene to be substituted one or more times by C₁-C₄-alkyl.

56. The process according to claim 55, wherein the intimate contacting additionally takes place in the presence of at least one additive selected from an antioxidant, light stabilizer, metal deactivator, antistatic agent, reinforcing agent, filler, antifogging agent, biocide and dispersing assistant other than the compounds of the formula I.

57. The process according to claim 56, wherein the dispersing assistant other than the compounds of the formula I is selected from polyethylene wax, polypropylene wax, metal soaps, fatty acid esters, montan wax, waxlike polymers, and amide wax.

58. The process according to claim 56 or 57, wherein the fraction of the dispersing assistant other than the compound of the formula I is less than 0.01% by weight, based on the total weight of the polymer composition.

59. The process according to claim 55, wherein no dispersing assistant other than the compound of the formula (I) is used.
